(19) United States
(12) Patent Application Publication
(10) Pub. No.: US 2026/0282025 A1
(43) Pub. Date: Sep. 17, 2026

(54) SIGNALLING OF UNUSED CG OCCASIONS

(71) Applicant: GOOGLE LLC, Mountain View, CA (US)

(72) Inventors: Abdellatif Salah, Mountain View, CA (US); Chih-Hsiang Wu, Taoyuan City (TW)

(21) Appl. No.: 19/473,430

(22) PCT Filed: Apr. 8, 2024
(86) PCT No.: PCT/US2024/023646

§ 371 Date: Oct. 7, 2025

Related U.S. Application Data
(60) Provisional application No. 63/495,080, filed on Apr. 7, 2023.

(51) Int. Cl. H04W 72/21; H04W 72/115

(52) U.S. Cl. CPC H04W 72/21; H04W 72/115

(57) ABSTRACT

A user equipment (UE) receives, from a radio access network (RAN), a periodic configuration that indicates (i) a plurality of occasions for uplink transmission within each period, and (ii) a subset of the plurality of occasions, the subset including two or more occasions, in which the UE is allowed to transmit a control indication related to another occasion; and transmits, in a first occasion included in the subset, the control indication for a second occasion not included in the subset and subsequent to the first occasion, the control indication based on whether the UE will transmit data in the second occasion.

### CROSS-REFERENCE TO RELATED APPLICATIONS

This application claims priority to and the benefit of the filing date of provisional U.S. Patent Application No. 63/495,080 entitled “SIGNALLING OF UNUSED CG OCCASIONS,” filed on Apr. 7, 2023. The entire contents of the provisional applications are hereby expressly incorporated herein by reference.

### FIELD OF THE DISCLOSURE

This disclosure relates to wireless communications and, more particularly, to managing communication using enhanced uplink (UL) scheduling mechanisms for real time media services (e.g., extended Reality services (XR) and cloud gaming (CG) services) utilizing high data rate and low latency. The disclosure proposes enhancement to the configured grant (CG) scheduling mechanisms to better support UL XR traffic and to improve system capacity by allowing the user equipment (UE) to dynamically signal an indication of the unused CG occasion(s) in one or multiple CG configurations.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

XR stands for extended Reality, which is an umbrella term that covers Augmented Reality (AR), Virtual Reality (VR) and Mixed Reality (MR). In virtual reality, the user is fully immersed in a virtual environment that is totally substituting the real environment by wearing a head-mounted device. Augmented reality augments the perception of the real environment with some virtual elements, so some virtual elements are overlaid on the perception of the real environment. Mixed reality is an extension of AR where the real and virtual elements can interact in real time. Cloud gaming runs video games on remote servers without the need for a gaming console or a high spec CPU and GPU to play these games. Cloud gaming streams a game like streaming a video, and the game will respond to the gamer commands and controls in real time.

Wireless AR/VR and wireless Cloud gaming offer better freedom of movement as wireless eliminates the geographical or behavioral restrictions and allows VR and AR users to move freely. Wireless AR/VR also enables new applications like remote education in immersive environment for remote areas not connected with good DSL or Fiber. Multiple XR scenarios and applications are deployed. Offline sharing of 3D objects consists of sharing 3D models or objects and 3D mixed reality scenes amongst users (e.g., using a phone equipped with a depth camera to capture an image in 3D and then share the image with a contact). XR conferencing is another use case and consist of people interacting in virtual environment and sharing a 3D experience with each other and even presenting some content and discuss it with other people in the same conference.

XR is a resource heavy service. In particular, XR has high data rates utilization and is improved with low latency and high reliability. However, such limits the system capacity, which introduces difficulties for deployment. In particular, scheduling enhancements are needed to allow for larger number of UEs to consume the service simultaneously. Scheduling enhancements can include new scheduling techniques, but also enhancement to existing techniques. Enhancements, to be efficient, should consider the specificities of the XR traffic (periodicities, packets sizes, jitter, etc.) as shown herein.

UL AR video traffic has variable frame sizes and the ratio between I-frame/slice and P-frame/slice is between 1.5 and 3 times. Therefore, using fixed size radio resource allocation is sub-optimal and will impact the system performance or the system efficiency, and therefore the system capacity.

Configured Grant scheduling is utilized for UL AR and for Pose Information scheduling in order to reduce latency compared to dynamic scheduling. However, further enhancements to Configured Grant scheduling are needed to enable the support of the UL XR service on 5G with good system capacity.

### SUMMARY

An example embodiment of the techniques of this disclosure is a method for uplink transmission implemented in a user equipment (UE), the method comprising: receiving, from a radio access network (RAN), a periodic configuration that indicates (i) a plurality of occasions for uplink transmission within each period, and (ii) a subset of the plurality of occasions, the subset including two or more occasions, in which the UE is allowed to transmit a control indication related to another occasion; and transmitting, in a first occasion included in the subset, the control indication for a second occasion not included in the subset and subsequent to the first occasion, the control indication based on whether the UE will transmit data in the second occasion.

Another example embodiment of these techniques is a method for configuring uplink transmission from a UE, the method implemented in a base station and comprising: transmitting, to the UE a periodic configuration that indicates (i) a plurality of occasions for uplink transmission within each period, and (ii) a subset of the plurality of occasions, the subset including two or more occasions, in which the UE is allowed to transmit a control indication related to another occasion; and receiving, in a first occasion included in the subset, the control indication for a second occasion not included in the subset and subsequent to the first occasion, the control indication indicating whether the UE will transmit data in the second occasion.

Still another example embodiment of these techniques is a device comprising a transceiver; and processing hardware configured to implement one of the methods above.

### BRIEF DESCRIPTION OF THE DRAWINGS

FIG. 1A is a block diagram of an example system in which a distributed base station and/or a user equipment (UE) can implement the techniques of this disclosure for managing a radio connection of the UE during early data transmission (EDT);

FIG. 1B is a block diagram of an example base station including a central unit (CU) and a distributed unit (DU) of a distributed base station that can operate in the system of FIG. 1A;

FIG. 2 is a block diagram of an example protocol stack according to which the UE of FIGS. 1A-B can communicate with base stations;

FIG. 3 is a signalling diagram that depicts the base station's configuration of the UE with a Configured Grant (CG) configuration containing multiple CG-PUSCH occasions. The signalling diagram also depicts the UE's transmission of multiple CG-PUSCH occasions when the UL data arrives and the CG period starts.

FIG. 4 shows an example of the transmission of multiple CG-PUSCH occasions across multiple slots in the CG period.

FIG. 5A shows the transmission of multiple CG-PUSCH occasions in one CG period where each CG occasion carrying PUSCH is also carrying a UCI indicating the unused CG occasions.

FIG. 5B shows the transmission of multiple CG-PUSCH occasions in one CG period where one RRC configured CG occasion carrying PUSCH is also carrying a UCI indicating the unused CG occasions.

FIG. 5C shows the transmission of multiple CG-PUSCH occasions in one CG period where one predefined/specified position of a CG occasion carrying PUSCH is also carrying a UCI indicating the unused CG occasions.

FIG. 5D shows the transmission of multiple CG-PUSCH occasions in one CG period where the first CG occasion transmitting PUSCH in the CG period is also carrying a UCI indicating the unused CG occasions.

FIG. 6 shows the transmission of multiple CG-PUSCH occasions in one CG period where any CG_PUSCH occasion transmitting PUSCH inside a specific window also carries a UCI indicating the unused CG occasions.

FIG. 7 is a flow diagram where the base station identifies the window for the UCI transmissions and then configures the UE with this window. Then, the UE can use this window to determine the CG occasions that should include the UCI transmission indicating the unused CG-PUSCH occasions.

FIG. 8A shows the transmission of multiple CG-PUSCH occasions in one CG period where a bitmap is used to indicate which CG occasion in the CG period can carry the UCI indicating the unused occasions with the PUSCH transmission.

FIG. 8B shows the transmission of multiple CG-PUSCH occasions in one CG period where multiple CG occasions in the CG period are configured by the base station to the UE to carry UCI indicating the unused occasions.

FIG. 9 shows a CG configuration where a bitmap is used to indicate in which CG cycle the CG-PUSCH can carry the UCI indicating the unused CG periods.

FIG. 10A shows a CG configuration where a periodicity is used to indicate in which CG cycle the CG-PUSCH can carry the UCI indicating the unused CG periods/occasions.

FIG. 10B shows a CG configuration where UCI can carry an indication that CG PUSCH periods within a specific range are going to be unused.

FIG. 10C shows a CG configuration where UCI can carry a bitmap to indicate which CG periods are maintained and which CG periods are going to be unused.

FIG. 10D shows a CG configuration where UCI indicates unused CG occasion(s) across CG configurations.

FIG. 11 shows a CG configuration where each CG-PUSCH carries the UCI indicating the unused CG periods.

FIG. 12 shows the transmission of multiple CG-PUSCH occasions in one CG period where a UCI indicates that the following CG occasion is going to be unused.

FIG. 13 shows the transmission of multiple CG-PUSCH occasions in one CG period where a UCI indicates that after a minimum time Tmin a CG occasion is going to be unused by the UE.

FIG. 14A shows multiple CG-PUSCH occasions transmitted within one CG period, with the CG occasion carrying the UCI (indicating unused CG occasions) is skipped.

FIG. 14B shows multiple CG-PUSCH occasions transmitted within one CG period, with the CG occasion carrying the UCI (indicating unused CG occasions) is skipped and the UCI is dropped.

FIG. 15 shows multiple CG-PUSCH occasions transmitted within one CG period, with the CG occasion carrying the UCI (indicating unused CG occasions) is skipped and the UCI is transmitted on the earliest occasion transmitting PUSCH.

FIG. 16 schematically illustrates how jitter can affect video traffic.

### DETAILED DESCRIPTION

The discussion below pertains to the technical field of wireless communication and discloses enhancement to the UL XR scheduling to support XR traffic with its stringent latency and reliability requirements. The XR traffic has large packets with variable sizes arriving quasi-periodically. New scheduling techniques and enhancements of the existing techniques are needed for the scheduling of the XR packets mainly for uplink Augmented Reality traffic, hence improving the system capacity and supporting more users consuming the service simultaneously. The enhancements are also needed to address the latency, reliability and system capacity limitations of the existing schemes.

### Example Architecture

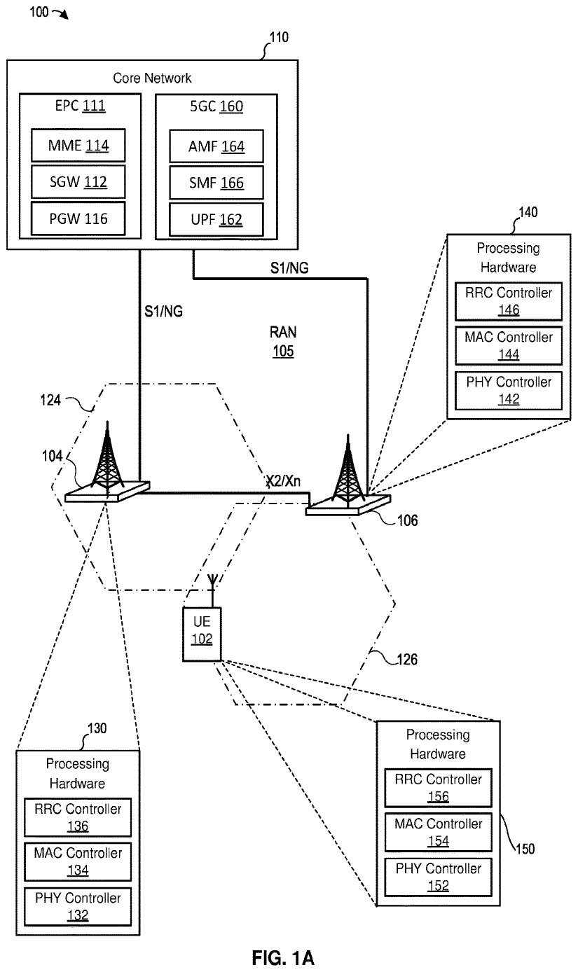

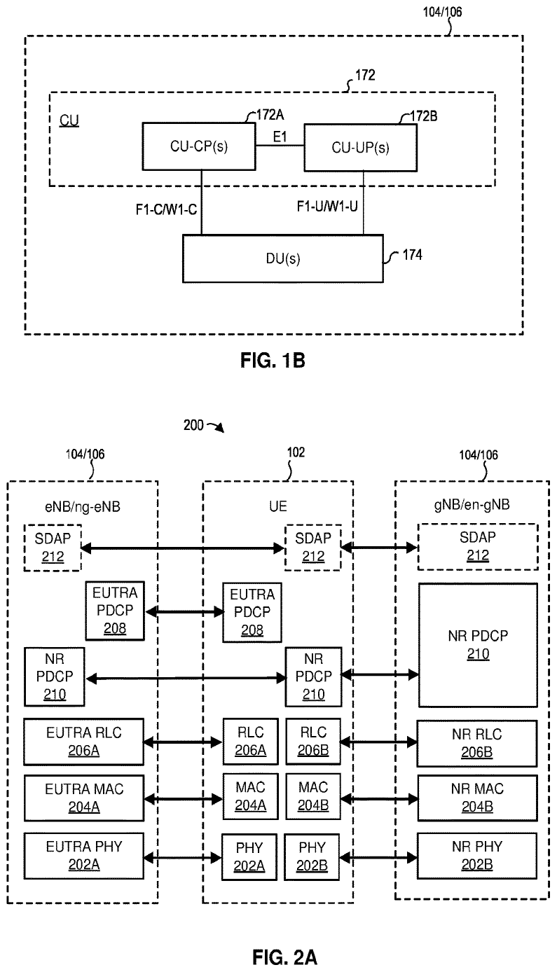

FIG. 1A depicts an example wireless communication system 100 in which communication devices can implement these techniques. The wireless communication system 100 includes a UE 102, a base station (BS) 104, a base station 106 and a core network (CN) 110. The UE 102 initially connects to the base station 104. In some scenarios, the base station 104 can perform an SN addition to configure the UE 102 to operate in dual connectivity (DC) with the base station 104 and the base station 106. The base stations 104 and 106 operate as an MN and an SN for the UE 102, respectively.

In various configurations of the wireless communication system 100, the base station 104 can be implemented as a master eNB (MeNB) or a master gNB (MgNB), and the base station 106 can be implemented as a secondary gNB (SgNB). The UE 102 can communicate with the base station 104 and the base station 106 via the same RAT such as EUTRA or NR, or different RATs. When the base station 104 is an MeNB and the base station 106 is a SgNB, the UE 102 can be in EUTRA-NR DC (EN-DC) with the MeNB and the SgNB.

In some cases, an MeNB or an SeNB is implemented as an ng-eNB rather than an eNB. When the base station 104 is a Master ng-eNB (Mng-eNB) and the base station 106 is a SgNB, the UE 102 can be in next generation (NG) EUTRA-NR DC (NGEN-DC) with the Mng-eNB and the SgNB. When the base station 104 is an MgNB and the base station 106 is an SgNB, the UE 102 may be in NR-NR DC (NR-DC) with the MgNB and the SgNB. When the base station 104 is an MgNB and the base station 106 is a Secondary ng-eNB (Sng-eNB), the UE 102 may be in NR-EUTRA DC (NE-DC) with the MgNB and the Sng-eNB.

In the scenarios where the UE 102 hands over from the base station 104 to the base station 106, the base stations 104 and 106 operate as the source base station (S-BS) and a target base station (T-BS), respectively. The UE 102 can operate in DC with the base station 104 and an additional base station (not shown in FIG. 1A) for example prior to the handover. The UE 102 can continue to operate in DC with the base station 106 and the additional base station or operate in single connectivity (SC) with the base station 106, after completing the handover. The base stations 104 and 106 in this case operate as a source MN (S-MN) and a target MN (T-MN), respectively.

A core network (CN) 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 can support an X2 or Xn interface. Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage Protocol Data Unit (PDU) sessions.

As illustrated in FIG. 1A, the base station 104 supports cell 124, and the base station 106 supports a cell 126. The cells 124 and 126 can partially overlap, so that the UE 102 can communicate in DC with the base station 104 and the base station 106, where one of the base stations 104 and 106 is an MN and the other is an SN. The base station 104 and base station 106 can support additional cell(s) (not shown in FIG. 1A). The base station 104 can operate the cells 124 and/or additional cell(s) via one or more transmit and receive points (TRPs). More particularly, when the UE 102 is in DC with the base station 104 and the base station 106, one of the base stations 104 and 106 operates as an MeNB, an Mng-eNB or an MgNB, and the other operates as an SgNB or an Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g., UE 102) via one or more cells and/or one or more TRPs. The PHY controller 132 is also configured to receive data and control signal on physical uplink (UL) channels and/or UL reference signals with the one or more user devices via one or more cells and/or one or more TRPs. The processing hardware 130 in an example implementation includes a MAC controller 134 configured to perform MAC functions with one or more user devices. The MAC functions include a random access (RA) procedure, managing UL timing advance for the one or more user devices, and/or communicating UL/DL MAC PDUs with the one or more user devices. The processing hardware 130 can further include an RRC controller 136 to implement procedures and messaging at the RRC sublayer of the protocol communication stack. For example, the RRC controller 132 may be configured to support RRC messaging associated with handover procedures, and/or to support the necessary operations when the base station 104 operates as an MN relative to an SN or as an SN relative to an MN. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells and/or one or more TRPs. The PHY controller 152 is also configured to transmit data and control signal on physical UL channels and/or UL reference signals with the base station 104 or 106 via one or more cells and/or one or more TRPs. The processing hardware 150 in an example implementation includes a MAC controller 154 configured to perform MAC functions with base station 104 or 106. For example, the MAC functions include a random-access procedure, managing UL timing advance for the one or more user devices, and communicating UL/DL MAC PDUs with the base station 104 or 106. The processing hardware 150 can further include an RRC controller 156 to implement procedures and messaging at the RRC sublayer of the protocol communication stack.

In operation, the UE 102 in DC can use a radio bearer (e.g., a DRB or an SRB) that at different times terminates at the MN 104 or the SN 106. The UE 102 can apply one or more security keys when communicating on the radio bearer, in the uplink (UL) (from the UE 102 to a base station) and/or downlink (from a base station to the UE 102) direction.

FIG. 1B depicts an example distributed implementation of a base station such as the base station 104 or 106. The base station in this implementation can include a centralized unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an SN RRC controller 142 configured to manage or control one or more RRC configurations and/or RRC procedures when the base station 106 operates as an SN. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random-access procedure) and a radio link control (RLC) controller configured to manage or control one or more RLC operations or procedures when the base station 106 operates as an MN or an SN. The process hardware may include further a physical layer controller configured to manage or control one or more physical layer operations or procedures.

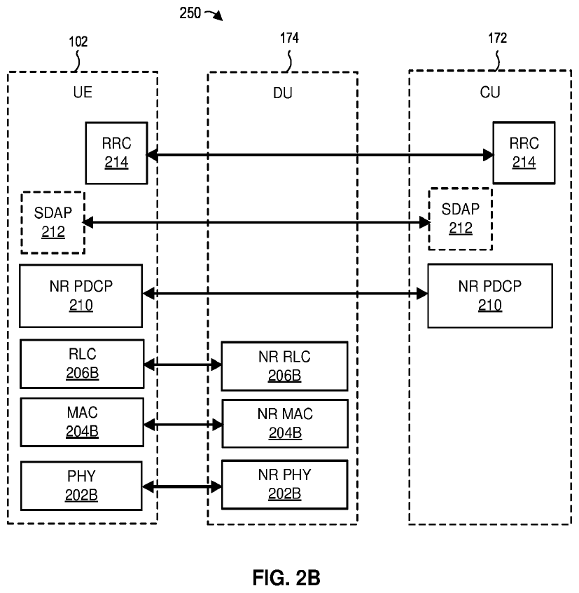

Next, FIG. 2 illustrates in a simplified manner a radio protocol stack according to which the UE 102 can communicate with an eNB/ng-eNB or a gNB. Each of the base stations 104 or 106 can be the eNB/ng-eNB or the gNB.

The physical layer (PHY) 202A of EUTRA provides transport channels to the EUTRA Medium Access Control (MAC) sublayer 204A, which in turn provides logical channels to the EUTRA Radio Link Control (RLC) sublayer 206A, and the EUTRA RLC sublayer in turn provides RLC channels to the EUTRA PDCP sublayer 208 and, in some cases, NR PDCP sublayer 210. Similarly, the PHY 202B of NR provides transport channels to the NR MAC sublayer 204B, which in turn provides logical channels to the NR RLC sublayer 206B, and the NR RLC sublayer 206B in turn provides RLC channels to the NR PDCP sublayer 210. The UE 102 in some implementations supports both the EUTRA and the NR stack, to support handover between EUTRA and NR base stations and/or DC over EUTRA and NR interfaces. Further, as illustrated in FIG. 2A, the UE 102 can support layering of NR PDCP 210 over EUTRA RLC 206A.

The EUTRA PDCP sublayer 208 and the NR PDCP sublayer 210 receive packets (e.g., from the Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 provide SRBs to exchange Radio Resource Control (RRC) messages, for example. On a user plane, the EUTRA PDCP sublayer 208 and the NR PDCP sublayer 210 provide DRBs to support data exchange.

When the UE 102 operates in EUTRA/NR DC (EN-DC), with the base station 104 operating as a MeNB and the base station 106 operating as a SgNB, the network can provide the UE 102 with an MN-terminated bearer that uses EUTRA PDCP 208 or MN-terminated bearer that uses NR PDCP 210. The network in various scenarios also can provide the UE 102 with an SN-terminated bearer, which use only NR PDCP 210. The MN-terminated bearer can be an MCG bearer or a split bearer. The SN-terminated bearer can be a SCG bearer or a split bearer. The MN-terminated bearer can be an SRB (e.g., SRB1 or SRB2) or a DRB. The SN-terminated bearer can an SRB (e.g., SRB) or a DRB.

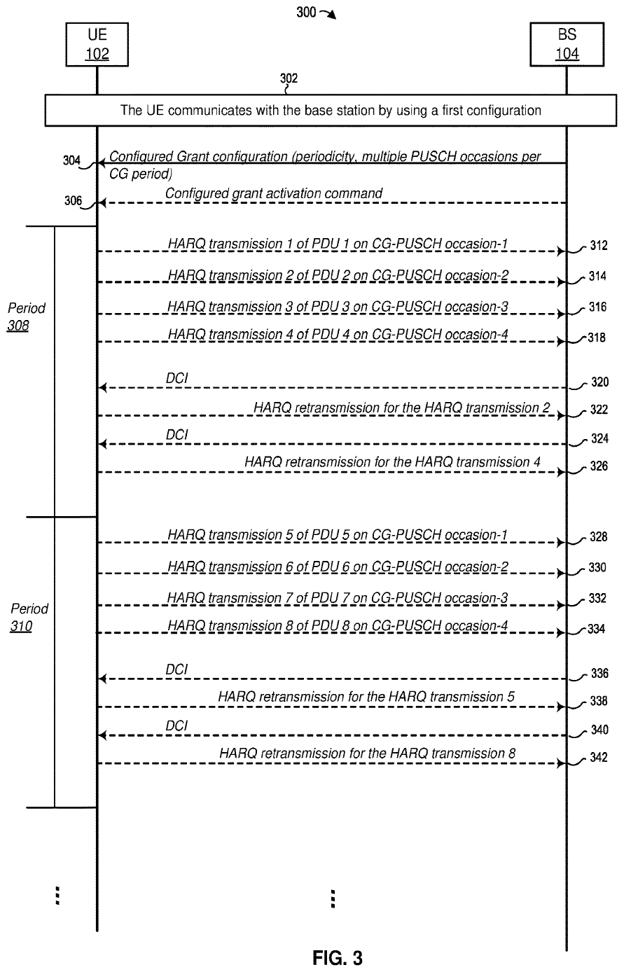

Referring first to FIG. 3, in a scenario 300, the UE 102 initially communicates 302 with the base station 104 using a first configuration. In some implementations, the UE 102 communicates 302 with the base station 104 on a licensed spectrum. In some implementations, the UE 102 in carrier aggregation (CA) communicates with the base station 104 on the cell 124 and other cell(s) using the first configuration. In other implementations, the UE 102 communicates with the base station 104 on the cell 124 only. In some implementations, the UE 102 communicates with the base station 104 on the cell 124 and/or other cell(s) via one or multiple TRPs. In some implementations, the cell 124 is a PCell or a PSCell. In such cases, the other cell(s) include SCell(s) and/or additional cell(s) associated with the PCell or a SCell. In other implementations, the cell 124 is a SCell, and one of the other cell(s) is a PCell. In such cases, the rest includes SCell(s) and/or additional cell(s) associated with the PCell or a SCell.

In some implementations, the UE 102 transmits UL PDUs and/or UL control signals to the base station 104 on the cell 124 and/or other cell(s) via one or multiple TRPs. In some implementations, the UE 102 communicates UL PDUs and/or DL PDUs with the base station 104 via radio bearers, which, in some implementations, include SRBs and/or DRB(s). In some implementations, the base station 104 configures the radio bearers to the UE 102. In some implementations, UL control signals include UL control information, channel state information, hybrid automatic repeat request (HARQ) acknowledgements (ACKs), HARQ negative ACKs, scheduling request(s) and/or sounding reference signal(s). Similarly, in further implementations, the UE 102 receives DL PDUs and/or DL control signals from the base station 104 on the cell 124 and/or other cell(s) via one or multiple TRPs. In some implementations, the DL control signals include downlink control information (DCIs) and reference signals (e.g., synchronization signal block, channel state information reference signal(s) (CSI-RS(s)), and/or tracking reference signal(s)). In some implementations, the base station 104 transmits the DCIs on physical downlink control channel(s) (PDCCH(s)) monitored by the UE 102, on the cell 124 and/or other cell(s) via one or multiple TRPs.

Later, the base station 104 transmits 304, to the UE 102, a message including a Configured Grant (CG) configuration configuring multiple CG-PUSCH occasions per CG period (e.g., 4 CG-PUSCH occasions 312, 314, 316, and 318). For example, the message is an RRC reconfiguration message. In some implementations, the base station 104 configures a periodicity for the CG period. In some implementations, the base station 104 includes a periodicity in the CG configuration to configure the CG period. In some implementations, the base station 104 configures the periodicity to align with at least one of UL XR traffic periodicities (30 fps, 60 fps, 90 fps, 120 fps, 240 fps, . . . ). In some implementations, specifically defined CG periodicities (i.e., new CG periodicity values) are used (e.g., specified in a 3GPP specification such as 3GPP technical specification (TS) 38.331), and the new CG periodicities are a rounding up/down of the UL XR traffic periodicities to the closest OFDM symbol or slot granularity. In some implementations, the base station 104 sets the periodicity to one of the new CG periodicity values. In other implementations, the base station 104 sets the periodicity to an existing CG periodicity value (e.g., defined in 3GPP TS 38.331). In some implementations, the UE 102 indicates, to the base station 104, a preferred periodicity based on UL data traffic of the UE 102 while communicating with the base station 104 in the event 302. For example, the UE 102 transmits a UEAssistanceInformation message including the preferred periodicity to the base station 104. In some implementations, the base station 104 sets the periodicity in the CG configuration to the preferred periodicity. In some implementations, the CG configuration is a predefined ConfiguredGrantConfig information element (IE) (e.g., defined in 3GPP TS 38.331). In some implementations, in the CG configuration, the base station 104 includes new configuration parameters configuring the multiple CG-PUSCH occasions to accommodate for UL traffic (e.g., UL XR traffic). In some implementations, the base station 104 includes the new configuration parameters in an IE (e.g., ConfiguredGrantConfig-Multiple-PUSCH-Occasions) and includes the IE in the CG configuration. In some implementations, the new parameters include a configuration parameter (e.g., cg-nrofPUSCH-CG-Cycle 410) to indicate the number of the CG-PUSCH occasions configured in the CG period. In further implementations, the base station 104 includes existing parameters cg-nrofPUSCH-InSlot and cg-nrofSlots (e.g., defined in 3GPP TS 38.331) in the CG configuration to configure the number of the CG-PUSCH occasions per CG period for CG transmissions on a licensed spectrum. Hence, the instant disclosure improves conventional system by removing the current restriction (e.g., in 3GPP TS 38.331) for networks to only configure the existing parameters cg-nrofPUSCH-InSlot and cg-nrofSlots for CG transmissions on an unlicensed spectrum.

In some implementations, after transmitting 304 the CG configuration to the UE 102, the base station 104 transmits 306 a CG activation command to the UE 102 to activate the CG configuration. In some implementations, the CG activation command is a DCI. In further implementations, the CG activation command is a MAC control element (CE). After (e.g., in response to) receiving the CG activation command, the UE 102 starts using the CG configuration to transmit data. In other implementations, the UE 102 starts using the CG configuration to transmit data after (e.g., in response to) receiving the CG configuration. In such cases, the event 306 is omitted. In some implementations, the base station 104 includes a CG (i.e., CG resource configuration) in the CG configuration. In other implementations, the base station 104 includes the CG in the CG activation command.

In some implementations, after receiving the CG configuration or CG activation command, the UE 102 generates one or more PDUs (e.g., MAC PDUs) including UL data, generates a HARQ transmission (e.g., HARQ new transmission) for each of the PDU(s), and transmits the HARQ transmission(s) using the CG on some or all of the CG-PUSCH occasions configured in the CG configuration. For example, if the UE 102 has UL data to transmit for the CG-PUSCH occasion-1, the UE 102 generates PDU 1 including the UL data, generates HARQ transmission 1 from the PDU 1, and transmits 312 the HARQ transmission 1 on the CG-PUSCH occasion-1 in CG period 308. If the UE 102 has UL data to transmit for the CG-PUSCH occasion-2, the UE 102 generates PDU 2 including the UL data, generates HARQ transmission 2, and transmits 314 the HARQ transmission 2 on the CG-PUSCH occasion-2 in CG period 308. If the UE 102 has UL data to transmit for the CG-PUSCH occasion-3, the UE 102 generates PDU 3 including the UL data, generates HARQ transmission 3, and transmits 316 the HARQ transmissions 3 on the CG-PUSCH occasion-3 in CG period 308. If the UE 102 has UL data to transmit for the CG-PUSCH occasion-4, the UE 102 generates PDU 4 including the UL data, generates HARQ transmission 4, and transmits 318 the HARQ transmissions 4 on the CG-PUSCH occasion-4 in CG period 308. In some implementations, the HARQ transmissions 1, 2, 3, and 4 are HARQ new transmissions or HARQ transmissions with redundancy version 0. In some implementations, the UE 102 has no UL data to transmit on a CG-PUSCH occasion (e.g., the CG-PUSCH occasion-1). In some such cases, the UE 102 skips the CG-PUSCH occasion. Alternatively, the UE 102 generates a PDU (e.g., MAC PDU) including padding bits without data, generates a HARQ transmission from the PDU, and transmit the HARQ transmission on the CG-PUSCH occasion. In some implementations, if the UE 102 has no UL data to transmit on a CG-PUSCH occasion and has uplink control information (UCI) to transmit, the UE 102 does not skip the CG-PUSCH occasion. In some such cases, the UE 102 generates a PDU (e.g., MAC PDU) including padding bits without data, generates a HARQ transmission from the PDU, and transmits the HARQ transmission and the UCI on the CG-PUSCH occasion.

In some scenarios or implementations, if the base station 104 fails to receive PDU(s) from HARQ transmission(s) that the UE 102 transmitted on CG-PUSCH occasion(s) in a CG period, the base station 104 transmits one or more DCIs to command the UE 102 to transmit one or more HARQ retransmissions of the PDU(s). In some implementations, each of the DCI(s) includes a redundancy version 0, 1, 2, or 3. In other implementations, each of the DCI(s) include a redundancy version with a value other than 0. For example, the value is set to 1, 2, or 3. For example, if the base station 104 fails to receive the PDU 2 and PDU 4 from the HARQ transmission 2 and HARQ transmission 4, respectively, the base station 104 transmits 320, to the UE 102, a first DCI that commands the UE 102 to transmit a HARQ retransmission for the HARQ transmission 2 and a HARQ retransmission for the HARQ transmission 4. In accordance with the first DCI, the UE 102 transmits 322 a HARQ retransmission and transmits 326 a HARQ retransmission for the HARQ transmission 2 and HARQ transmission 4, respectively, to the base station 104. In some implementations, the first DCI includes a dynamic grant for the two HARQ retransmissions, and the UE 102 transmits 322 the HARQ retransmission and transmits 326 the HARQ retransmission in accordance with the dynamic grant. In other implementations, the first DCI includes a first dynamic grant and a second dynamic grant for the HARQ retransmission for the HARQ transmission 2 and the HARQ retransmission for the HARQ transmission 4, respectively. In such cases, the UE 102 transmits 322 the HARQ transmission and transmits 326 the HARQ retransmission in accordance with the first dynamic grant and second dynamic grant, respectively.

In another example, the base station 104 transmits 320, to the UE 102, a second DCI that commands the UE 102 to transmit a HARQ retransmission for the HARQ transmission 2 and transmits 324, to the UE 102, a third DCI that commands the UE 102 to transmit a HARQ retransmission for the HARQ transmission 4. The UE 102 transmits 322 a HARQ retransmission and transmits 326 a HARQ retransmission for the HARQ transmission 2 and HARQ transmission 4 in accordance with the second DCI and the third DCI, respectively. In some implementations, the second DCI includes a single dynamic grant, and the UE 102 transmits 322 the HARQ retransmission in accordance with the dynamic grant. In some implementations, the third DCI includes a single dynamic grant, and the UE 102 transmits 326 the HARQ retransmission in accordance with the dynamic grant.

In some implementations, if the base station 104 determines that the UE 102 supports a single DCI (e.g., a particular DCI format) scheduling multiple PUSCH transmissions, the base station 104 determines to transmit or transmits, to the UE 102, a single DCI that commands the UE 102 to transmit multiple HARQ retransmissions for HARQ transmissions that the UE 102 transmit on CG-PUSCH occasions. For example, the base station 104 transmits the first DCI because the UE 102 supports a single DCI (e.g., a particular DCI format) scheduling multiple PUSCH transmissions. Otherwise, if the base station 104 determines that the UE 102 does not support a single DCI (e.g., a particular DCI format) scheduling multiple PUSCH transmissions, the base station 104 determines to transmit or transmits, to the UE 102, a DCI that commands the UE 102 to transmit a HARQ retransmission for only a HARQ transmission that the UE 102 transmits on a CG-PUSCH occasion. For example, the base station 104 transmits the second DCI and third DCI because the UE 102 does not support a single DCI (e.g., a particular DCI format) scheduling multiple PUSCH transmissions.

In some implementations, the base station 104 detects whether the UE 102 skips a CG-PUSCH occasion due to having no UL data available for transmission on the CG-PUSCH occasion. If the base station 104 detects a CG-PUSCH occasion skipped by the UE 102, the base station 104 refrains from transmitting a DCI that commands the UE 102 to transmit a HARQ retransmission for the CG-PUSCH occasion. For example, if the base station 104 detects the CG-PUSCH occasion-2 skipped by the UE 102, the base station transmits neither the first DCI nor the second DCI. In some implementations, the base station 104 determines whether to enable the UE 102 to skip a CG-PUSCH occasion when the UE 102 has no UL data available for transmission on the CG-PUSCH occasion. In some implementations, if the base station 104 determines that the UE 102 supports skipping a CG-PUSCH occasion among multiple CG-PUSCH occasions in a CG period when the UE 102 has no UL data available for transmission on the CG-PUSCH occasion, the base station 104 enables the UE 102 to skip a CG-PUSCH occasion due to having no UL data available for transmission on the CG-PUSCH occasion. If the base station 104 determines that the UE 102 does not support skipping a CG-PUSCH occasion among multiple CG-PUSCH occasions in a CG period when the UE 102 has no UL data to transmit on the CG-PUSCH occasion, the base station 104 disables or refrains from enabling the UE 102 to skip a CG-PUSCH occasion among multiple CG-PUSCH occasions in a CG period when the UE 102 has no UL data to transmit on the CG-PUSCH occasion.

In some implementations, in the next CG period 310, the UE 102 generates one or more PDUs (e.g., MAC PDUs) including UL data, generates a HARQ transmission (e.g., HARQ new transmission) for each of the PDU(s), and transmits the HARQ transmission(s) using the CG on some or all of the CG-PUSCH occasions configured in the CG configuration. For example, if the UE 102 has UL data to transmit for the CG-PUSCH occasion-1, the UE 102 generates PDU 5 including the UL data, generates HARQ transmission 5 from the PDU 5, and transmits 328 the HARQ transmissions 5 on the CG-PUSCH occasion-1 in CG period 310. If the UE 102 has UL data to transmit for the CG-PUSCH occasion-2, the UE 102 generates PDU 6 including the UL data, generates HARQ transmission 6, and transmits 330 the HARQ transmissions 6 on the CG-PUSCH occasion-2 in CG period 310. If the UE 102 has UL data to transmit for the CG-PUSCH occasion-3, the UE 102 generates PDU 7 including the UL data, generates HARQ transmission 7, and transmits 332 the HARQ transmissions 7 on the CG-PUSCH occasion-3 in CG period 310. If the UE 102 has UL data to transmit for the CG-PUSCH occasion-8, the UE 102 generates PDU 8 including the UL data, generates HARQ transmission 8, and transmits 334 the HARQ transmissions 8 on the CG-PUSCH occasion-4 in CG period 310. In some implementations, the HARQ transmissions 5, 6, 7, and 8 are HARQ new transmissions or HARQ transmissions with redundancy version 0. In some implementations, the UE 102 has no UL data to transmit on a CG-PUSCH occasion (e.g., the CG-PUSCH occasion-6 or CG-PUSCH occasion-7). In some such cases, the UE 102 skips the CG-PUSCH occasion. Alternatively, the UE 102 generates a PDU (e.g., MAC PDU) including padding bits without data, generates a HARQ transmission from the PDU, and transmits the HARQ transmission on the CG-PUSCH occasion. In some implementations, if the UE 102 has no UL data to transmit on a CG-PUSCH occasion and has uplink control information (UCI) to transmit, the UE 102 does not skip the CG-PUSCH occasion. In some such cases, the UE 102 generates a PDU (e.g., MAC PDU) including padding bits without data, generates a HARQ transmission from the PDU, and transmits the HARQ transmission and the UCI on the CG-PUSCH occasion.

In some scenarios or implementations, if the base station 104 fails to receive PDU(s) from HARQ transmission(s) that UE 102 transmitted on CG-PUSCH occasion(s) in a CG period, the base station 104 transmits one or more DCIs to command the UE 102 to transmit one or more HARQ retransmissions of the PDU(s). In some implementations, each of the DCI(s) includes a redundancy version with a value set to 0, 1, 2, or 3. In other implementations, each of the DCI(s) include a redundancy version with a value other than 0, For example, the value can be set to 1, 2, or 3. For example, if the base station 104 fails to receive the PDU 5 and PDU 8 from the HARQ transmission 5 and HARQ transmission 8, respectively, the base station 104 transmits 336, to the UE 102, a fourth DCI that commands the UE 102 to transmit a HARQ retransmission for the HARQ transmission 5 and a HARQ retransmission for the HARQ transmission 8. In accordance with the fourth DCI, the UE 102 transmits 338 a HARQ retransmission and transmits 342 a HARQ retransmission for the HARQ transmission 5 and HARQ transmission 8 to the base station 104, respectively. In some implementations, the fourth DCI includes a dynamic grant for the two HARQ retransmissions, and the UE 102 transmits 338 the HARQ retransmission and transmits 342 the HARQ retransmission in accordance with the dynamic grant. In other implementations, the fourth DCI includes a first dynamic grant and a second dynamic grant for the HARQ retransmission for the HARQ transmission 5 and the HARQ retransmission for the HARQ transmission 8, respectively. In such cases, the UE 102 transmits 338 the HARQ transmission and transmits 342 the HARQ retransmission in accordance with the first dynamic grant and second dynamic grant, respectively.

In another example, the base station 104 transmits 336 to the UE 102 a fifth DCI that commands the UE 102 to transmit a HARQ retransmission for the HARQ transmission 5 and transmits 340 to the UE 102 a sixth DCI that commands the UE 102 to transmit a HARQ retransmission for the HARQ transmission 8. The UE 102 transmits 338 a HARQ retransmission and transmits 342 a HARQ retransmission for the HARQ transmission 5 and HARQ transmission 8 in accordance with the fifth DCI and the sixth DCI, respectively. In some implementations, the fifth DCI includes a single dynamic grant, and the UE 102 transmits 338 the HARQ retransmission in accordance with the dynamic grant. In some implementations, the sixth DCI includes a single dynamic grant, and the UE 102 transmits 342 the HARQ retransmission in accordance with the dynamic grant.

In some implementations, if the base station 104 determines that the UE 102 supports a single DCI (e.g., a particular DCI format) scheduling multiple PUSCH transmissions, the base station 104 determines to transmit or transmits, to the UE 102, a single DCI that commands the UE 102 to transmit multiple HARQ retransmissions for HARQ transmissions that the UE 102 transmit on CG-PUSCH occasions. For example, the base station 104 transmits the fourth DCI because the UE 102 supports a single DCI (e.g., a particular DCI format) scheduling multiple PUSCH transmissions. Otherwise, if the base station 104 determines that the UE 102 does not support a single DCI (e.g., a particular DCI format) scheduling multiple PUSCH transmissions, the base station 104 determines to transmit or transmits, to the UE 102, a DCI that commands the UE 102 to transmit a HARQ retransmission for only a HARQ transmission that the UE 102 transmits on a CG-PUSCH occasion. For example, the base station 104 transmits the fifth DCI and sixth DCI because the UE 102 does not support a single DCI (e.g., a particular DCI format) scheduling multiple PUSCH transmissions.

In some implementations, the base station 104 transmits an enabling indication to the UE 102 to enable the UE 102 to skip a CG-PUSCH occasion among multiple CG-PUSCH occasions in a CG period due to having no UL data available for transmission on the CG-PUSCH occasion. For example, the base station 104 includes the enabling indication in the message 304. In another example, the base station 104 transmits another message (e.g., RRC reconfiguration message), including the enabling indication, to the UE 102. In some implementations, if the UE 102 receives the enabling indication and has no data available for transmission on one of multiple CG-PUSCH occasions in a CG period, the UE 102 skips the CG-PUSCH occasion. Otherwise, if the UE 102 does not receive the enabling indication and has no data available for transmission on one of multiple CG-PUSCH occasions in a CG period, the UE 102 generates a PDU (e.g., MAC PDU) including padding bits without data, generates a HARQ transmission from the PDU, and transmits the HARQ transmission on the CG-PUSCH occasion.

In some implementations, the UE 102 transmits, to the base station 104, a UE capability indicating that the UE 102 supports skipping a CG-PUSCH occasion among multiple CG-PUSCH occasions in a CG period when the UE 102 has no UL data to transmit on the CG-PUSCH occasion. In some implementations, the UE 102 transmits a UE-NR-Capability IE, including the UE capability, to the base station 104. In further implementations, the UE 102 transmits a UE-6G-Capability IE, including the UE capability, to the base station 104. In other implementations, the base station 104 receives the UE capability from a core network (e.g., AMF) or the base station 106. In some implementations, the base station 104 receives the UE-NR-Capability IE, including the UE capability, from the core network or base station 106. In some implementations, the UE capability is predefined (e.g., defined in 3GPP TS 38.331 and 38.306) and/or different from an enhancedSkipUplinkTxConfigured-r16 IE (e.g., defined in 3GPP TS 38.331 and 38.306). In some implementations, because the enhancedSkipUplinkTxConfigured-r16 IE is specified for a legacy CG configuration configuring a single CG-PUSCH occasion per CG period, a UE supporting the enhancedSkipUplinkTxConfigured-r16 does not support skipping a CG-PUSCH occasion among multiple CG-PUSCH occasions in a CG period when the UE 102 has no UL data to transmit on the CG-PUSCH occasion. In other implementations, the UE capability is the enhancedSkipUplinkTxConfigured-r16 IE (e.g., defined in 3GPP TS 38.331 and 38.306). In such cases, the enhancedSkipUplinkTxConfigured-r16 IE is extended to indicate supporting skipping a CG-PUSCH occasion among multiple CG-PUSCH occasions in a CG period when the UE 102 has no UL data to transmit on the CG-PUSCH occasion.

In some implementations, the base station 104 determines whether to configure multiple CG-PUSCH occasions per CG period for the UE 102 based on whether the UE 102 supports multiple CG-PUSCH occasions per CG period. If the base station 104 determines that the UE 102 supports multiple CG-PUSCH occasions per CG period, the base station 104 transmits 304 the CG configuration to the UE 102. Otherwise, if the base station 104 determines that the UE 102 does not support multiple CG-PUSCH occasions per CG period, the base station 104 does not transmit the CG configuration. In some such cases, the base station 104 transmits a CG configuration configuring a single CG-PUSCH occasion per CG period to the UE 102. In some examples, the base station 104 includes the CG configuration in the message 304 instead of the CG configuration configuring multiple CG-PUSCH occasions per CG period.

In some implementations, the UE 102 transmits, to the base station 104, a UE capability indicating that the UE 102 supports multiple CG-PUSCH occasions per CG period. In some implementations, the UE 102 transmits a UE-NR-Capability IE, including the UE capability, to the base station 104. In further implementations, the UE 102 transmits a UE-6G-Capability IE, including the UE capability, to the base station 104. In other implementations, the base station 104 receives the UE capability from a core network (e.g., AMF) or the base station 106. In some implementations, the base station 104 receives the UE-NR-Capability IE, including the UE capability, from the core network or base station 106. In some implementations, the UE capability is predefined (e.g., defined in 3GPP TS 38.331 and 38.306).

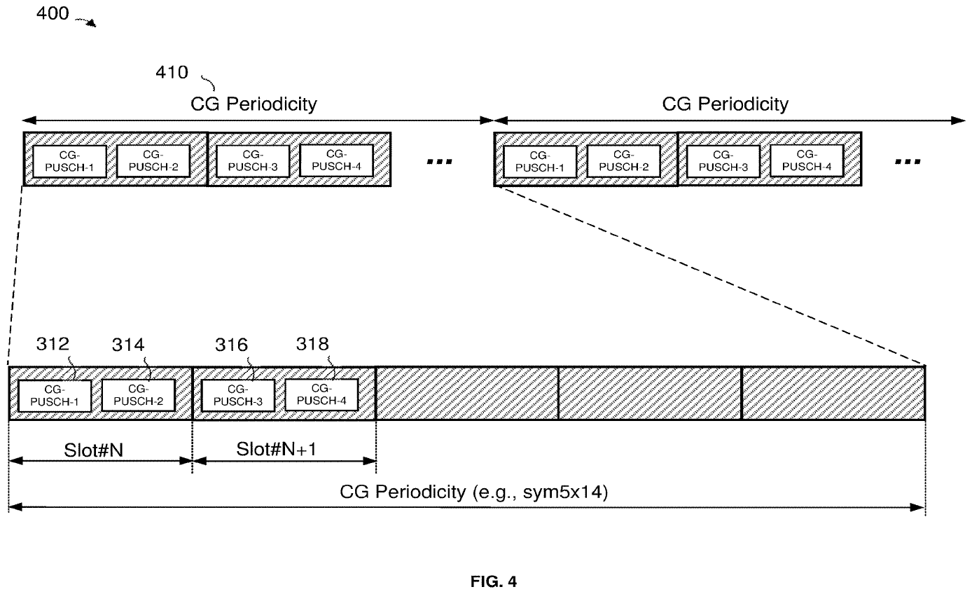

Referring to FIG. 4, the UE 102 is configured with multiple CG-PUSCH occasions per CG period as described for FIG. 3. In FIG. 4, four (4) CG-PUSCH occasions 312, 314, 316, 318 are configured per CG period/periodicity. Depending on the implementation, the CG-PUSCH occasions in a CG period are assigned to one or multiple slots. In some implementations, the allocation is identical in all slots, meaning the same time and frequency resources assigned to the CG-PUSCH occasions in one slot are replicated to other slots. Alternatively, different frequency and time allocations are allocated to each slot.

In some implementations, if the UE 102 has no UL data to transmit for a CG-PUSCH occasion in a CG period, the UE 102 skips the CG-PUSCH occasion (i.e., the UE 102 skips or refrains from transmitting a CG-PUSCH transmission on the CG-PUSCH occasion). For example, depending on the implementation, the CG-PUSCH occasion is the CG-PUSCH-1 312, CG-PUSCH-2 314, CG-PUSCH-3 316, or CG-PUSCH-4 318. In some implementations, when the UE 102 has UL data to transmit for a first CG-PUSCH occasion right after the skipped CG-PUSCH occasion(s), the UE 102 transmits a skipping indication to the base station 104 to indicate the skipped CG-PUSCH occasion(s) on the first transmitted CG-PUSCH occasion. Based on the skipping indication, the base station 104 determines the UE 102 skips the one or more consecutive CG-PUSCH occasions instead of determining CG-PUSCH transmission(s) on the one or more consecutive CG-PUSCH occasions are missing. Without the skipping indication, the base station 104 will attempt to schedule the UE 102 to transmit HARQ retransmission(s) for the missing CG-PUSCH transmission(s) because the base station 104 fails to receive CG-PUSCH transmission(s) on the one or more consecutive CG-PUSCH occasions. In some implementations, the UE 102 includes the skipping indication in a CG-PUSCH transmission that the UE 102 transmits on a CG-PUSCH occasion.

As the UL AR traffic is quasi-periodic with stringent latency requirements, it is very beneficial to use Configured Grant rather than UL dynamic scheduling, as the latter technique sends a scheduling request (SR) and then receives a UL grant to send the buffer status report (BSR), and then sends the actual UL scheduling DCI. Such signalling overhead (SR, BSR, and UL DCI) consumes resources and increases the latency, hence the motivation to use the Configured Grant with some enhancements to address the variable frame sizes and reduce the signalling overhead.

Enhancements for XR includes specifying the enhancements related to capacity: (i) multiple CG PUSCH transmission occasions in a period of a single CG PUSCH configuration; and (ii) dynamic indication of unused CG PUSCH occasion(s) based on UCI by the UE.

According to one approach, for dynamic indication of unused CG PUSCH occasion(s) based on a UCI, the following options are available for a transmission occasion of the UCI: (i) a transmitted CG PUSCH includes the UCI; (ii) a transmitted CG PUSCH includes the UCI, if the CG PUSCH is transmitted in an occasion determined by RRC; (iii) a transmitted CG PUSCH includes the UCI, if the CG PUSCH is transmitted in a predefined transmission occasion (e.g., a first configured PUSCH TO in a CG period or a first configured PUSCH TO in a multiple CG periods); (iv) a transmitted CG PUSCH includes the UCI, if the CG PUSCH is transmitted in a transmission occasion determined satisfying given condition(s) (e.g., a first transmitted PUSCH in a CG period, or a first PUSCH transmission within a multiple of CG periods).

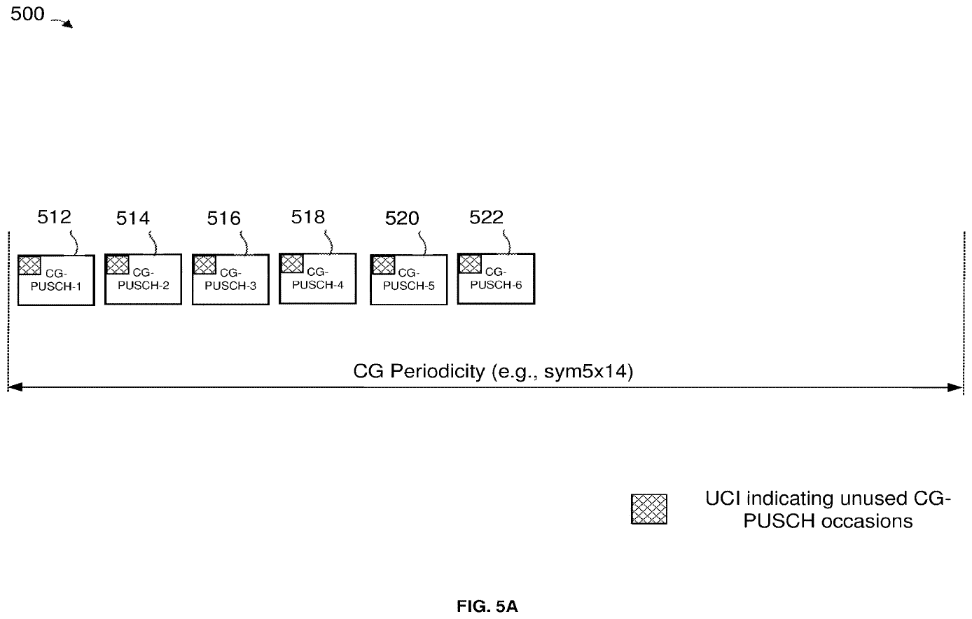

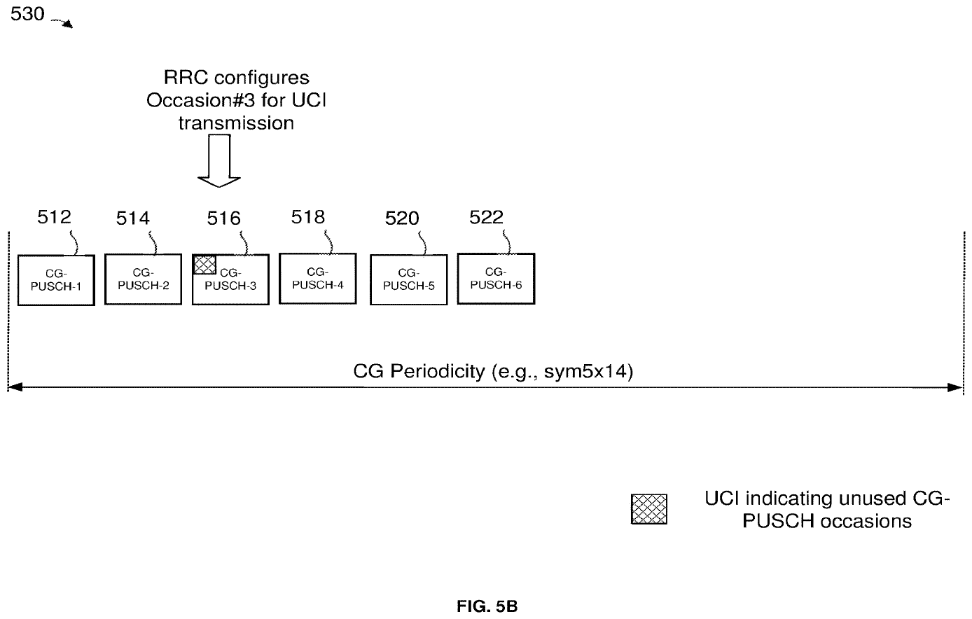

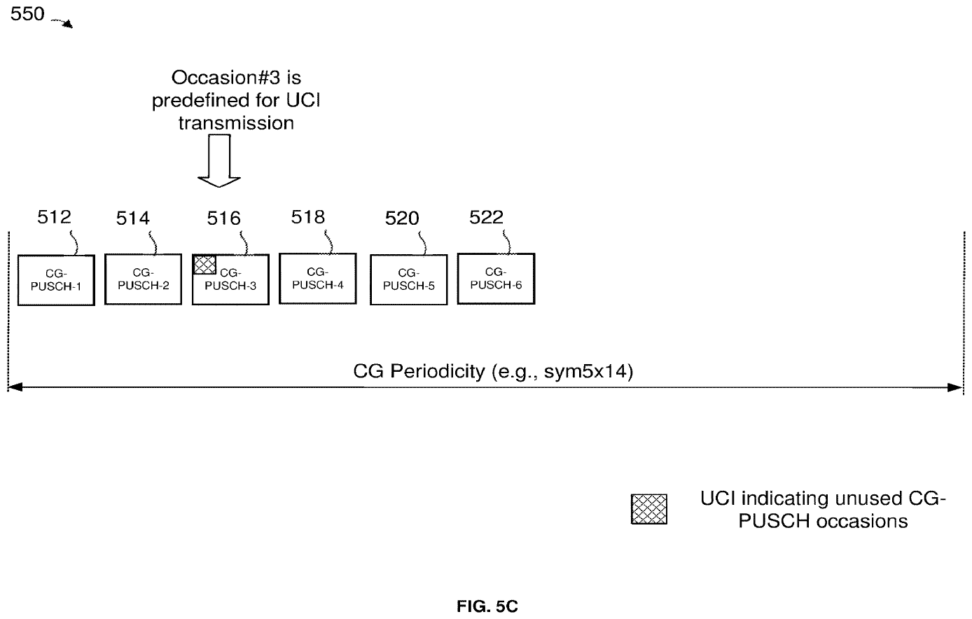

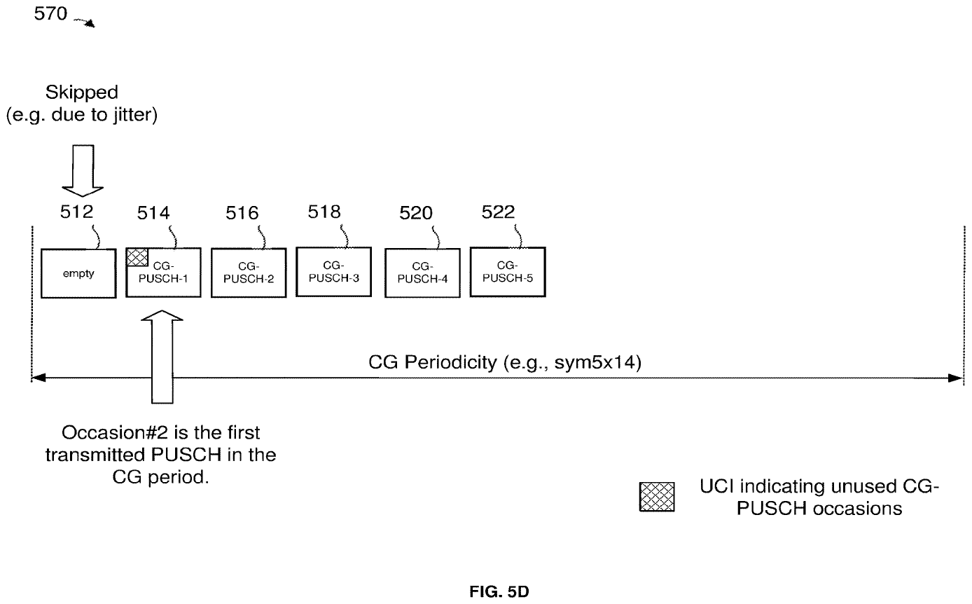

The options above specify how a UE can signal the CG occasion(s) that will be unused by the UE. The UE uses UCI to signal the unused occasions and transmits the UCI with CG PUSCH transmissions. The four options above are illustrated in FIG. 5A, FIG. 5B, FIG. 5C, and FIG. 5D. Each option comes with advantages and drawbacks compared to each other, though all represent an improvement over conventional systems.

Referring to FIG. 5A, according to a scheme 500 (also referred to herein as “Option 1”), a UE 102 repeats UCIs in each CG PUSCH occasion 512, 514, 516, 518, 520, 522. Depending on the scenario, each instance of the UCI includes the same information or information consistent with the previous UCIs. Hence, in some implementations, even if the base station 104 misses one or multiple CG-PUSCH transmissions, the base station still obtains the information from other CG-PUSCH transmission occasions.

Referring next to FIG. 5B, a scheme 530 (also referred to herein as “Option 2”) provides better resource efficiency compared to Option 1, as the UE 102 transmits the UCI on a single occasion configured by the base station via an RRC configuration. In particular, an RRC configuration configures which occasion includes a UCI that indicates the unused CG PUSCH occasions (e.g., in the example of FIG. 5B, RRC configures the third CG occasion 516 for UCI transmission). In addition, Option 2 offers good flexibility to the base station to configure a preferred CG PUSCH occasion.

Referring next to FIG. 5C, a scheme 550 (“Option 3”) is generally similar to Option 2 and offers better resource efficiency compared to Option 1, as the UE 102 transmits the UCI on a single predefined occasion. In particular, a transmitted CG PUSCH includes the UCI if the CG PUSCH is transmitted in a predefined transmission occasion (e.g., the third CG occasion 516 is predefined for UCI transmission in the example of FIG. 5C). One example of a predetermined occasion is using the first configured PUSCH occasion in a CG period. In some implementations, if the predetermined occasion consists of using the first configured PUSCH occasion in a CG period, then the scheme 550 is sensitive to jitter if the first configured PUSCH occasion is skipped.

Referring next to FIG. 5D, a scheme 570 (“Option 4”) is generally similar to Option 3, but in which the UE 102 transmits the UCI with the first CG PUSCH transmission in the CG period, which, in some implementations, is variable depending on the jitter. In particular, a transmitted CG PUSCH includes the UCI if the CG PUSCH is transmitted in a transmission occasion determined to satisfy given condition(s) (e.g., a first transmitted PUSCH in a CG period, a first PUSCH transmission within multiple CG periods, etc.). In the example of FIG. 5D, the UE skips the first occasion 512 as empty, and occasion 2 (e.g., the second occasion 514) is the first transmitted PUSCH in the CG period. Option 4 has the advantage of transmitting the information about the unused occasions as early as possible with the first CG PUSCH transmission from the UE, hence giving the base station the maximum time possible to recycle the unused occasions for other UEs.

Option 1 solves the general problem discussed herein and improves overall signaling overhead compared to conventional systems, while improving overall reliability compared to Options 2, 3, and 4 (e.g., by transmitting the UCI with each CG-PUSCH transmission. Moreover, with regard to the other options (e.g., Option 4), the UCI transmission can have a variable occasion position and be transmitted on different occasion from one CG period to another, hence increasing the uncertainty at the network side especially if the first CG-PUSCH transmission in the CG period is missed by the base station. In some such cases, the base station blindly decodes the following CG-PUSCH transmission (e.g., assuming UCI or no UCI) as the base station is not aware that the first transmission has been missed. Because Option 1 transmits the UCI with each transmission, such risk is mitigated.

In contrast, Options 2, 3, and 4 improve overall resource efficiency by reducing the number of transmissions of the UCI (e.g., rather than the UE 102 transmitting the UCI with each CG-PUSCH transmission in the CG cycle). Further, Options 2, 3, and 4 reduce the UE processing used in Option 1 to include the information on each CG PUSCH transmission. Still further, Options 2, 3, and 4 provide more complete information about the data to be transmitted and the CG occasion(s) to be cancelled from the start of the CG period, reducing the time the video frame from the application layer takes to fully arrive at the UE modem buffer. As such, while each option provides improvements and solves the problem discussed herein, each has various advantages compared to each other.

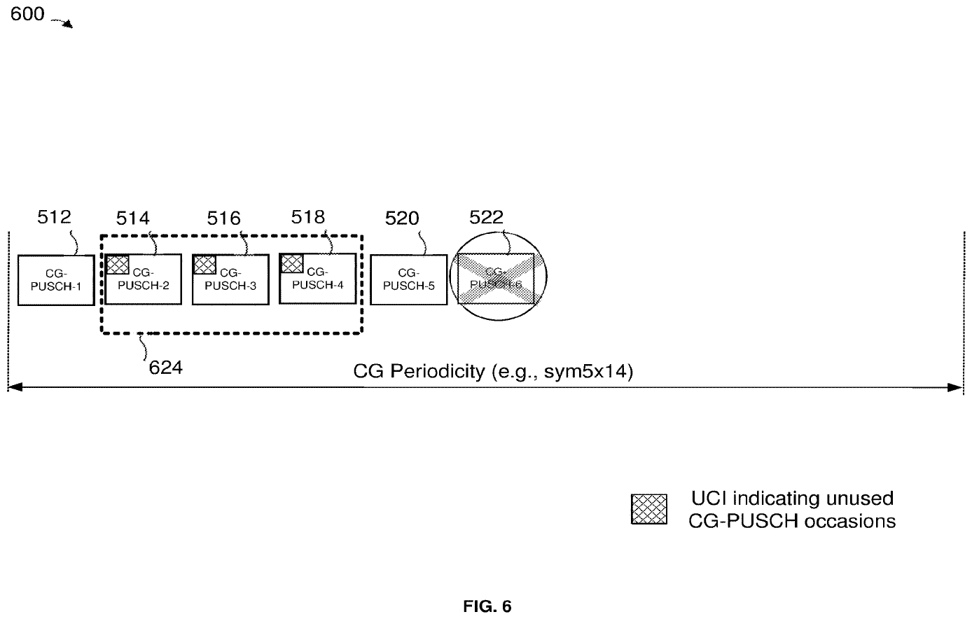

Referring next to FIG. 6, to reduce the signalling overhead and account for the jitter and for the base station processing time of the UCI, the base station 104, in some implementations, configures the UE 102 with a set of consecutive CG occasion(s) for the UE 102 in each CG period to transmit UCI indicating status (e.g., unused and/or used/to be used CG occasion(s)) for one or more CG occasions in each CG period. As described in FIG. 3, the base station 104 configures the UE 102 with multiple CG occasions per CG period. The multiple CG occasions include the consecutive CG occasion(s). In some implementations, the base station 104 transmits, to the UE 102, an RRC reconfiguration message including a configuration to configure the set of consecutive CG occasion(s). Depending on the implementation, the RRC reconfiguration message is the RRC reconfiguration message of event 304 or another RRC reconfiguration message. When the UE 102 has data to transmit on one or more CG occasions in the set in a CG period, the UE 102 transmits, to the base station 104, CG-PUSCH transmission(s) including the data on the CG occasion(s) in accordance with a CG resource configuration as described for FIG. 3. On each of the CG occasion(s) in the set, the UE 102 transmits UCI indicating status (e.g., unused or used/to be used CG occasions) for one or more CG occasions in the CG period to the base station 104, in accordance with the configuration. In some implementations, if the UE 102 has no data available for a CG occasion in the set, the UE 102 transmits neither a CG-PUSCH transmission nor the UCI on the CG occasion. In other implementations, if the UE 102 has no data available for a CG occasion in the set, the UE 102 does not transmit a CG-PUSCH transmission on the CG occasion and still transmits the UCI on the CG occasion.

In some implementations, when the UE 102 determines one or more unused CG occasions and one or more used CG occasions for a CG period, the UE 102 generates UCI indicating the unused CG occasion(s) and transmits the UCI together with CG-PUSCH transmission(s) on CG occasion(s) in the set. In such cases, the UE 102 does not indicate the used CG occasion(s) in the UCI. When the UE 102 determines all CG occasions in a CG period are used, the UE 102 generates UCI indicating no unused CG occasion and transmits the UCI together with CG-PUSCH transmission(s) on CG occasion(s) in the set. In other implementations, when the UE 102 determines one or more unused CG occasions and one or more used CG occasions for a CG period, the UE generates UCI indicating the unused CG occasion(s) and the used CG occasion(s), and transmits the UCI together with CG-PUSCH transmission(s) on CG occasion(s) in the set. When the UE 102 determines all CG occasions in a CG period are used, the UE 102 generates UCI indicating the used CG occasions and transmits the UCI together with CG-PUSCH transmission(s) on CG occasion(s) in the set.

In some implementations, the UE 102 includes other information in the UCI described above. For example, the other information includes channel state information and/or HARQ feedback. The HARQ feedback includes a HARQ acknowledgement or a HARQ negative acknowledgement. In other implementations, the UE 102 refrains from including the other information in the UCI described above (e.g., because there is no sufficient resources for the UE 102 to include the other information in the UCI). In yet other implementations, if the UE 102 has channel state information and/or HARQ feedback to transmit on a CG occasion within the set, the UE 102 generates UCI including the channel state information and/or HARQ feedback instead of the information indicating the unused CG occasion(s) and/or used CG occasion(s), and transmits the UCI on the CG occasion. In some implementations, the UE 102 does so because there is no sufficient resources for the UE 102 to include the other information in the UCI. Thus, the UE 102 prioritizes transmission of the channel state information and/or HARQ feedback in a higher priority than the information indicating the unused CG occasion(s) and/or used CG occasion(s).

In some implementations, the UE 102 refrains from transmitting UCI that indicates unused CG occasion(s) and/or used CG occasion(s) together with CG-PUSCH transmission(s) on CG occasion(s) outside the set. In some implementations, if the UE 102 has channel state information and/or HARQ feedback to transmit on a CG occasion outside the set, the UE 102 generates UCI including the channel state information and/or HARQ feedback, and transmits the UCI together with a CG-PUSCH transmission on the CG occasion. In some such cases, the UE 102 refrains from including information indicating used CG occasion(s) and/or used CG occasion(s) in the UCI. Alternatively, the UE 102 includes information indicating used CG occasion(s) and/or used CG occasion(s) in the UCI.

In some implementations, if the UCI does not indicate that a CG occasion is unused, the UE 102 transmits a CG-PUSCH transmission on the CG occasion. In some implementations, if the UE 102 does not have data available for transmission for the CG occasion, the UE 102 skips transmitting a CG-PUSCH transmission on the CG occasion. In one implementation, if the UE 102 is configured to enable skipping UL transmission due to having no data available for transmission, the UE 102 skips transmitting a CG-PUSCH transmission on the CG occasion. In some implementations, the base station 104 transmits a skipping UL transmission configuration (e.g., enhancedSkipUplinkTxConfigured) to the UE 102 to configure the UE 102 to enable skipping UL transmission due to having no UL data available for transmission. In some implementations, the UE 102 transmits a UE capability indicating support for skipping UL transmission due to having no UL data available for transmission to the base station 104, or the base station 104 receives the UE capability from a core network (e.g., the AMF 164) or base station 106. In such cases, the base station 104 transmits the skipping UL transmission configuration to the UE 102 based on the UE capability.

In some implementations, if the UCI does not indicate that a CG occasion is unused, the UE 102 transmits a CG-PUSCH transmission on the CG occasion. In some implementations, if the UE 102 does not have data available for transmission for the CG occasion, the UE 102 skips transmitting a CG-PUSCH transmission on the CG occasion. In some implementations, if the UE 102 is configured to enable skipping UL transmission due to having no data available for transmission, the UE 102 skips transmitting a CG-PUSCH transmission on the CG occasion. In some implementations, the base station 104 transmits a skipping UL transmission configuration (e.g., enhancedSkipUplinkTxConfigured) to the UE 102 to configure the UE 102 to enable skipping UL transmission due to having no UL data available for transmission. In some implementations, the UE 102 transmits a UE capability indicating support for skipping UL transmission due to having no UL data available for transmission to the base station 104, or the base station 104 receives the UE capability from a core network (e.g., the AMF 164) or base station 106. In such cases, the base station 104 transmits the skipping UL transmission configuration to the UE 102 based on the UE capability.

In other implementations, if the UE 102 does not have data available for transmission for the CG occasion, the UE 102 still generates a CG-PUSCH transmission and transmits the CG-PUSCH transmission on the CG occasion. If the CG occasion is in the set, the UE 102 transmits the UCI together with the CG-PUSCH transmission. Otherwise, if the CG occasion is not in the set, the UE 102 does not transmit the UCI together with the CG-PUSCH transmission. In some implementations, if the UE 102 does not support skipping UL transmission due to having no data available for transmission or the UE 102 is not configured to enable skipping UL transmission due to having no data available for transmission, the UE 102 generates a CG-PUSCH transmission and transmits the CG-PUSCH transmission on the CG occasion.

To simplify the following description, a “window” is used below to refer to “the set of consecutive CG occasion(s)”.

For example, in FIG. 6, the base station 104 configures a plurality of CG occasions 512, 514, 516, 518, 520, and 522 per CG period and configures a configured range (e.g., a window 624) including the CG occasions 514, 516 and 518 per CG period. The UE 102 transmits a CG-PUSCH-1 transmission on the CG occasion 512. The UE 102 has data available for transmission on the CG occasions 514, 516, and 518, and transmits CG-PUSCH-2 transmission, CG-PUSCH-3 transmission, and CG-PUSCH-4 transmission on the CG occasions 514, 516, and 518, respectively. The UE 102 also transmits CG-PUSCH-5 transmission on the CG occasion 520. The UE 102 determines that no data is available for transmission for the CG occasion 522 (e.g., the CG occasion 522 is to be unused) and generates UCI indicating the unused CG occasion 522. The UE 102 transmits the UCI together with the CG-PUSCH-2, CG-PUSCH-3, and CG-PUSCH-4 transmissions on the CG occasions 514, 516, and 518, respectively, and does not transmit the UCI on the CG occasions 512 and 520. In some implementations, the UE 102 multiplexes UCI with each of the CG-PUSCH-2 transmission, the CG-PUSCH-3 transmission, and the CG-PUSCH-4 transmission. In some implementations, the UE 102 indicates only unused CG occasion(s) (i.e., in the UCI).

Depending on the implementation, if the UE 102 has no data available for transmission on the CG occasion 520 due to jitter after transmitting the UCI, the UE 102 skips or does not skip the CG-PUSCH-5 transmission depending on whether the UE 102 supports skipping UL transmission or is configured with skipping UL transmission, as described above.

If the UE 102 transmits a CG-PUSCH transmission on the CG occasion 522, the UE generates UCI indicating no unused CG occasions, and transmits the UCI together with the CG-PUSCH-2, CG-PUSCH-3, and CG-PUSCH-4 transmissions as described above. If the UE 102 does not have data available for transmission on the CG occasion 520, the UE 102 does not transmit a CG-PUSCH transmission on the CG occasion 520. In such cases, the UE 102 indicates the unused CG occasion 520 in the UCI. If the UE 102 does not have data available for transmission on the CG occasion 512 (e.g., due to jitter), the UE 102 does not transmit a CG-PUSCH transmission on the CG occasion 512. In some implementations, the UE 102 indicates the unused CG occasion 512 in the UCI. In other implementations, the UE 102 does not indicate the unused CG occasion 512 in the UCI.

In some implementations, the base station 104 excludes one or more starting CG occasions (e.g., the CG occasion 512) because of the UE UL jitter. In other implementations, the base station 104 removes one or more CG occasions (e.g., the CG occasion 520 and 522) at the end of the CG period because the CG occasions would be too late for the base station 104 to recycle radio resources configured for the CG occasions if the base station 104 receives the UCI on the CG occasions. In such embodiments, any transmitted CG-PUSCH inside the configured window 624 includes a UCI indicating to the base station 104 the status of the CG occasions (e.g., unused CG occasion(s) and/or used/to be used CG occasion(s)) in the current CG period or in multiple CG periods. In some implementations, the base station 104 signals, to the UE 102, the length and the start offset of the window 624. In further implementations, the base station 104 signals, to the UE 102, the start and the end of the window 624. Depending on the implementation, the window parameters (start, end, length, . . . ) are in units of slots, OFDM symbols, or transmit occasions (e.g., using transmit occasion indices within the CG period). In some implementations, the base station 104 configures the UE 102 with the window 624 (and the associated parameters) semi-statically (e.g., via RRC signalling) or dynamically (e.g., via DCI signalling). In further examples, the window parameters are specified/predefined. In yet further examples, the window 624 is configured semi-statically (e.g., via RRC signalling) and adjusted dynamically (e.g., via DCI signalling). The UE 102 in some such implementations checks if a CG-PUSCH transmission is within the window 624, then sends the UCI with the CG-PUSCH to indicate the CG occasion(s) status (e.g., unused CG occasion(s) and/or used/to be used CG occasion(s)). In some examples, the indicated unused occasions are located between the start of the window 624 and the last CG-PUSCH occasion of the CG period included. In further examples, the indicated unused occasions are located between the end of the window 624 and the last CG-PUSCH occasion of the CG period included. In yet further examples, CG occasions before the start of the window 624 are not included in the signalling of the unused CG-PUSCH occasions, as the base station 104 is no longer able to recycle the CG occasions.

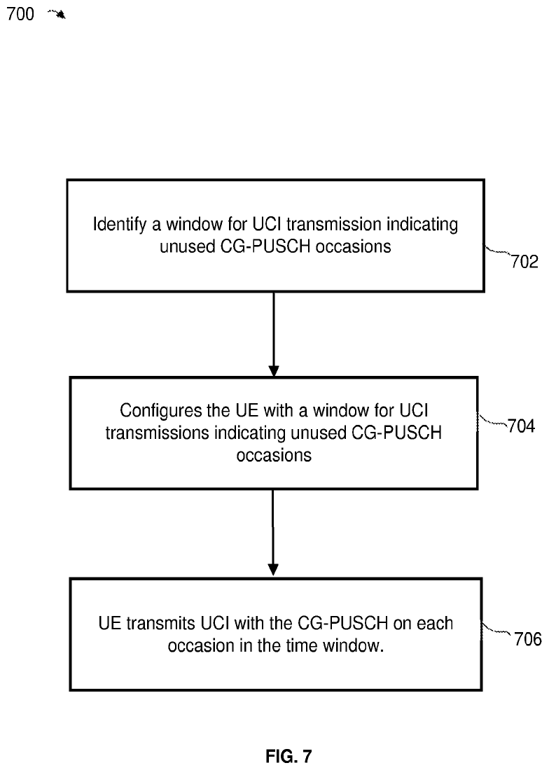

FIG. 7 is a flow diagram of an example method 700, which can be implemented in the base station 104 for example. According to the method 700, the base station 104 identifies the window for the UCI transmissions at block 702, and then configures the UE 102 with the window at block 704. The UE 102 then uses the window to determine the CG occasions that should include the UCI transmission indicating the CG occasion(s) status (e.g., unused CG occasion(s) and/or used/to be used CG occasion(s)). In some implementations, such is defined as a UE feature and the UE 102 reports, to the base station 104, support or lack thereof with regard to the feature. In some implementations, the base station 104 enables and/or disables such a feature semi-statically (e.g., via RRC signalling) and/or dynamically (e.g., via DCI signalling). At block 706, the UE 102 transmits the UCI with the CG-PUSCH on each occasion in the time window.

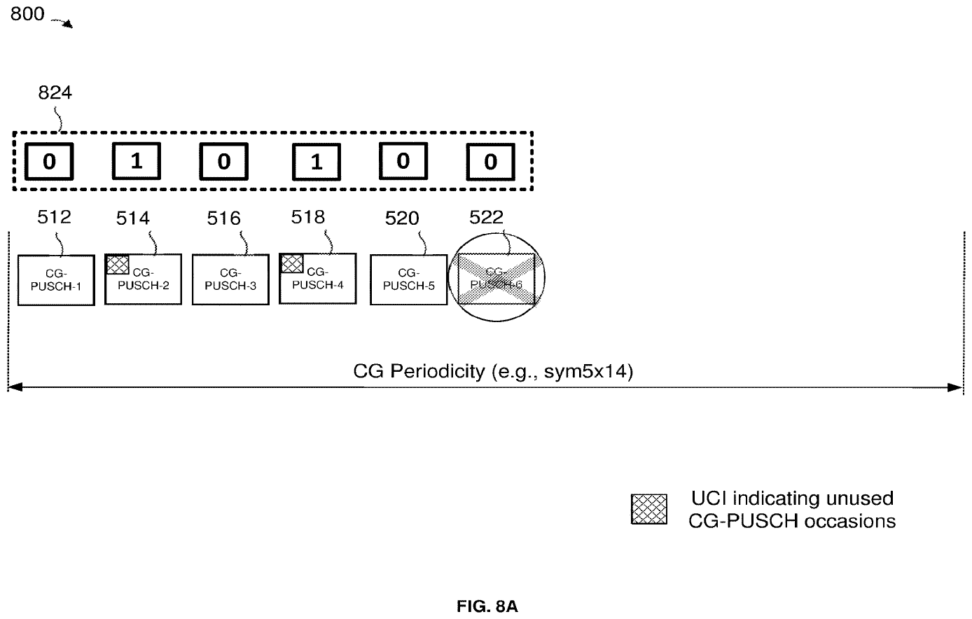

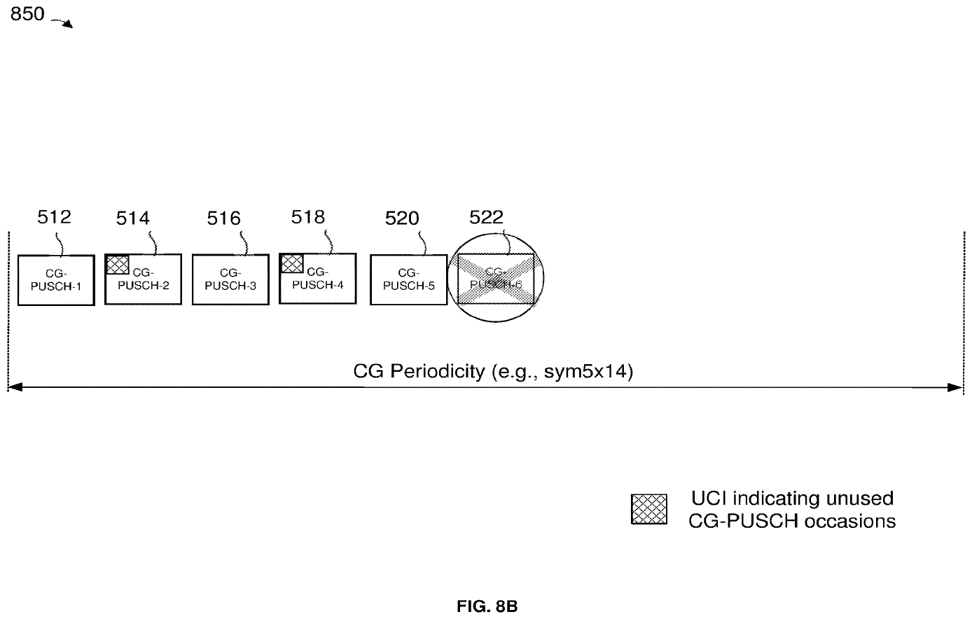

Referring next to FIG. 8A, to reduce the signalling overhead and account for the jitter and the base station processing time of the UCI, the base station 104 in some implementations configures the UE 102 with a bitmap 824 indicating the CG occasions on which the UCI transmission can take place. The bitmap has the flexibility of having non-consecutive occasions carrying the indication compared to using a window. In some implementations, the bitmap has as a length the number of CG occasions in the CG period. In further implementations, the bitmap has as a length a number larger than the number of CG occasions in the CG period. In some implementations, the bitmap maps CG occasions across multiple CG periods. In some implementations, such mapping is defined as a UE feature, and the UE 102 reports, to the base station 104, support or lack thereof with regard to the feature. In some implementations, the base station 104 enables and/or disables the feature semi-statically (e.g., via RRC signalling) and/or dynamically (e.g., via DCI signalling).

For example, in FIG. 8A, the base station 104 configures a plurality of CG occasions 512, 514, 516, 518, 520, and 522 per CG period, and configures a bitmap mapping to the CG occasions 512, 514, 516, 518, 520, and 522. The bitmap is for the UE 102 to determine on which CG occasion the UCI indicating the unused CG occasions should be transmitted. In the example of FIG. 8A, the UE 102 has data available for transmission on the CG occasion 512. The UE 102 checks the bitmap and determines no UCI indicating that the unused CG occasion is to be transmitted together with the CG-PUSCH-1 on the CG occasion 512. The UE 102 transmits a CG-PUSCH-1 transmission on the CG occasion 512 without the UCI indicating the unused CG occasion(s). The UE 102 has data available for transmission on the CG occasions 514. The UE 102 checks the bitmap and determines a UCI indicating the unused CG occasion is to be transmitted together with the CG-PUSCH-2 on the CG occasion 514. The UE 102 determines no data available for transmission for the CG occasion 522 (e.g., the CG occasion 522 is to be unused) and generates UCI indicating the unused CG occasion 522. The UE 102 transmits a CG-PUSCH-2 transmission on the CG occasion 514 with the UCI indicating the unused CG occasion(s). The UE 102 has data available for transmission on the CG occasion 516. The UE 102 checks the bitmap and determines no UCI indicating the unused CG occasion is to be transmitted together with the CG-PUSCH-3 on the CG occasion 516. The UE 102 transmits a CG-PUSCH-3 transmission on the CG occasion 516 without the UCI indicating the unused CG occasion(s). The UE 102 has data available for transmission on the CG occasions 518. The UE 102 checks the bitmap and determines a UCI indicating the unused CG occasion is to be transmitted together with the CG-PUSCH-4 on the CG occasion 518. The UE 102 determines no data available for transmission for the CG occasion 522 and generates UCI indicating the unused CG occasion 522. The UE 102 transmits a CG-PUSCH-4 transmission on the CG occasion 518 with the UCI indicating the unused CG occasion(s). The UE 102 has data available for transmission on the CG occasion 520. The UE 102 checks the bitmap and determines that no UCI indicating the unused CG occasion(s) is to be transmitted together with the CG-PUSCH-5 on the CG occasion 520. The UE 102 transmits a CG-PUSCH-5 transmission on the CG occasion 520 without the UCI indicating the unused CG occasion(s). The UE 102 has no data available for transmission on the CG occasion 522 and has already indicated that the CG occasion 522 will be unused and should comply with the indication. If there is UCI indicating the unused CG occasion(s) and the UCI needs to be transmitted on the CG occasion 522, then, in some implementations, the UE 102 still transmits the UCI multiplexed with dummy data. In such cases, the CG occasion is still transmitted even if indicated as unused to carry the UCI indicating the unused CG occasion(s). In other implementations, the UE 102 does not transmit any data on the CG occasion 522 and does not transmit the UCI. In other implementations, if there is more CG occasion(s) in the same period to be transmitted, the UE 102 postpones the UCI to the next used CG occasion. In some implementations, the UE 102 generates the UCI indicating the unused CG occasion(s) at the start of the CG period. In some other implementations, the UE 102 generates the UCI indicating the unused CG occasion(s) separately for each CG occasion carrying the UCI. In some implementations, the UE 102 transmits the same UCI in the CG occasion(s) carrying the UCI. In some other implementations, the UE 102 transmits different and/or updated UCI in the CG occasion(s) carrying the UCI, and the UE 102 overwrites and/or changes the CG occasions that are going to be unused. In some other implementations, the UE 102 transmits consistent UCI in the CG occasion(s) carrying the UCI (i.e., the UCI content is different, but the unused CG occasions remain constant).

Referring next to FIG. 8B, the base station 104, in some implementations, configures the UE 102 with multiple CG occasions per CG period on which the UCI transmission indicating the CG occasion(s) status (e.g., unused CG occasion(s) and/or used/to be used CG occasion(s)) can take place. In some implementations, the base station 104 configures the UE 102 with multiple CG occasions semi-statically (e.g., via RRC signalling) to carry the UCI indication. In further implementations, the base station 104 overwrites the configuration to indicate different CG occasions to carry the UCI indication. In some implementations, the overwriting is via RRC re-configuration or via dynamic signalling (e.g., via DCI). In further examples, multiple CG occasions to carry the UCI indicating the CG occasion(s) status (e.g., unused CG occasion(s) and/or used/to be used CG occasion(s)) are defined using some predefined rules. For example, UE 102 transmits the UCI every other CG occasion in the CG period. In yet another example, the UE 102 always transmits UCI on the first CG occasion if the first CG occasion has a CG-PUSCH transmission, and in another CG occasion, such as the middle occasion or the occasion with the CG occasion index (in the CG period) equal to

$$⌊ \frac{N}{2} ⌋ or ⌈ \frac{N}{2} ⌉$$

where N is the number of CG occasions per CG period and └ ┘ is the rounding down to the nearest integer and ┌ ┐ is the rounding up to the nearest integer.

For example, in FIG. 8B, the base station 104 configures a plurality of CG occasions 512, 514, 516, 518, 520, and 522 per CG period, and configures semi-statically (e.g., via RRC, MAC-CE, . . . ) CG occasion 514 and CG occasion 518 to carry the UCI indicating the unused CG occasion(s). In the example of FIG. 8B, the UE 102 has data available for transmission on the CG occasion 512. The UE 102 checks the configuration (RRC, MAC-CE, . . . ) and determines no UCI indicating the unused CG occasion is to be transmitted together with the CG-PUSCH-1 on the CG occasion 512. The UE 102 transmits a CG-PUSCH-1 transmission on the CG occasion 512 without the UCI indicating the unused CG occasion(s). The UE 102 has data available for transmission on the CG occasions 514. The UE 102 checks the configuration (RRC, MAC-CE, . . . ) and determines a UCI indicating that the unused CG occasion is to be transmitted together with the CG-PUSCH-2 on the CG occasion 514. The UE 102 determines no data available for transmission for the CG occasion 522 (e.g., the CU occasion 522 is to be unused) and generates UCI indicating the unused CG occasion 522. The UE 102 transmits a CG-PUSCH-2 transmission on the CG occasion 514 with the UCI indicating the unused CG occasion(s). The UE 102 has data available for transmission on the CG occasion 516. The UE 102 checks the configuration (RRC, MAC-CE, . . . ) and determines no UCI indicating the unused CG occasion is to be transmitted together with the CG-PUSCH-3 on the CG occasion 516. The UE 102 transmits a CG-PUSCH-3 transmission on the CG occasion 516 without the UCI indicating the unused CG occasion(s). The UE 102 has data available for transmission on the CG occasions 518. The UE 102 checks the configuration (RRC, MAC-CE, . . . ) and determines that UCI indicating the unused CG occasion is to be transmitted together with the CG-PUSCH-4 on the CG occasion 518. The UE 102 determines no data available for transmission for the CG occasion 522 and generates UCI indicating the unused CG occasion 522. The UE 102 transmits a CG-PUSCH-4 transmission on the CG occasion 518 with the UCI indicating the unused CG occasion(s). The UE 102 has data available for transmission on the CG occasion 520. The UE 102 checks the configuration (RRC, MAC-CE, . . . ) and determines no UCI indicating the unused CG occasion(s) is to be transmitted together with the CG-PUSCH-5 on the CG occasion 520. The UE 102 transmits a CG-PUSCH-5 transmission on the CG occasion 520 without the UCI indicating the unused CG occasion(s). The UE 102 has no data available for transmission on the CG occasion 522 and has already indicated the CG occasion 522 will be unused and should comply with the indication. If there is UCI indicating the unused CG occasion(s) and the UCI is configured to be transmitted on the CG occasion 522, then, in some implementations, the UE 102 still transmits the UCI multiplexed with dummy data. In such cases, the UE 102 still transmits the CG occasion even if indicated as unused to carry the UCI indicating the unused CG occasion(s). In other implementations, the UE 102 does not transmit any data on the CG occasion 522 and does not transmit the UCI. In other implementations, the UE 102 has more CG occasion(s) in the same period to be transmitted, the UE 102 postpones the UCI to the next used CG occasion.

In some implementations, the UE 102 generates the UCI indicating the unused CG occasion(s) at the start of the CG period. In some other implementations, the UE 102 generates the UCI indicating the unused CG occasion(s) separately for each CG occasion carrying the UCI. In some implementations, the UE 102 transmits the same UCI in the CG occasion(s) carrying the UCI. In some other implementations, the UE 102 transmits different and/or updated UCI in the CG occasion(s) carrying the UCI, and the UE 102 overwrites the CG occasions that are going to be unused. In some other implementations, the UE 102 transmits consistent UCI in the CG occasion(s) carrying the UCI (i.e., the UCI content is different but the unused CG occasions are constant).

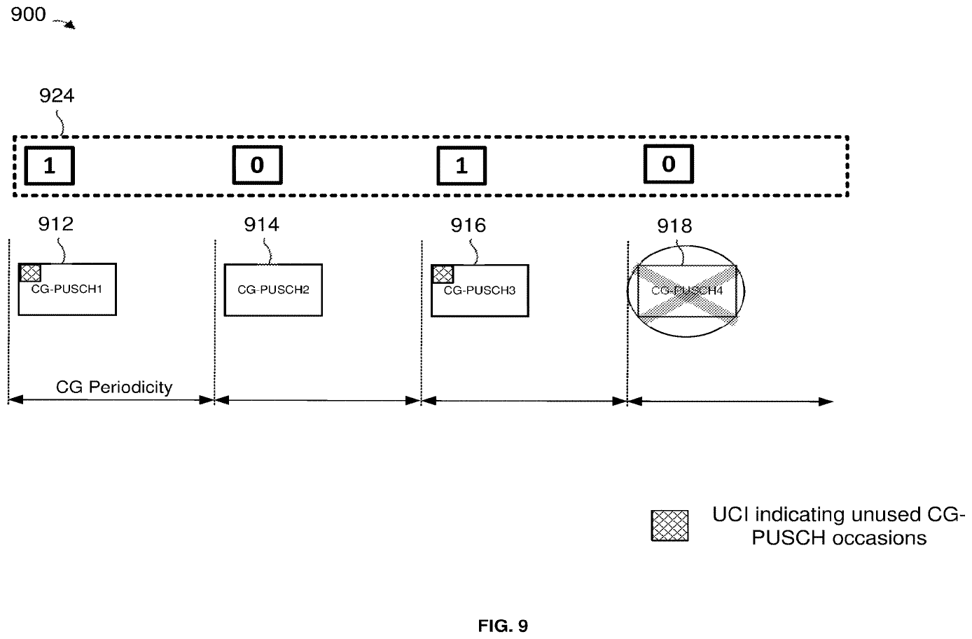

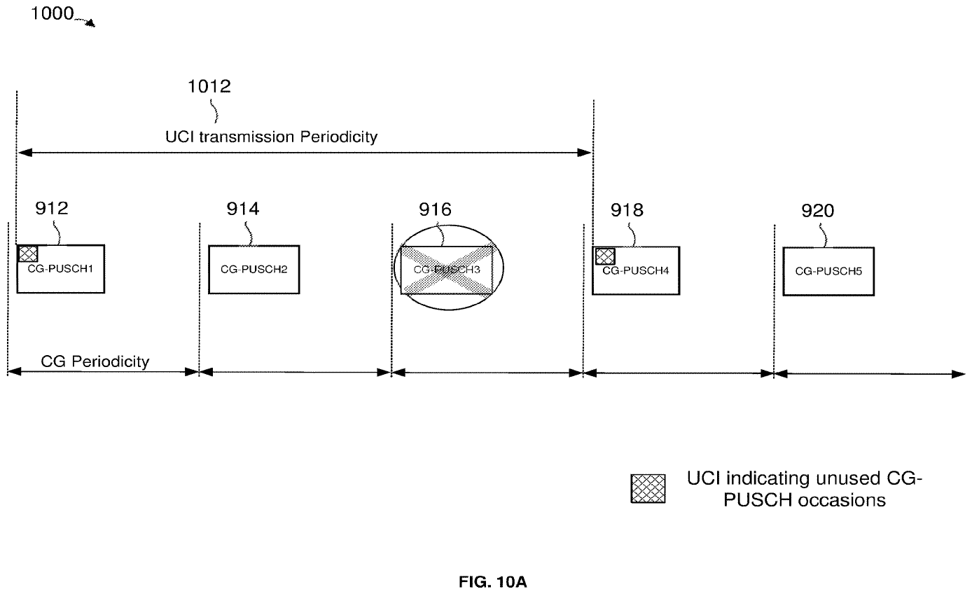

Referring next to FIG. 9, and using a CG configuration, each bit in the bitmap 924 in some implementations is associated with a CG period, and when the bit is set to 0, the UE 102 does not transmit UCI indicating the CG occasion(s) status (e.g., unused CG occasion(s) and/or used/to be used CG occasion(s)) with the CG-PUSCH transmission in the particular CG period. When the bit is set to 1, the UE 102 transmits UCI indicating the CG occasion(s) status (e.g., unused CG occasion(s) and/or used/to be used CG occasion(s)) with the CG-PUSCH transmission in the particular CG period. In some implementations, the base station 104 configures the UE 102 with the bitmap semi-statically (e.g., via RRC signalling) or dynamically (e.g., via DCI signalling). In another example, the bitmap is specified and/or predefined. In yet another example, the bitmap is configured semi-statically (e.g., via RRC signalling) and adjusted dynamically (e.g., via DCI signalling). In some implementations, the UE 102 checks if a CG-PUSCH transmission is associated with a value of 0 or 1 in the bitmap, then sends the UCI with the CG-PUSCH indicating the CG occasion(s) status (e.g., unused CG occasion(s) and/or used/to be used CG occasion(s)) if the associated value in the bitmap is equal to 1. In some implementations, such is defined as a UE feature, and the UE 102 reports, to the base station 104, support or lack thereof with regard to the feature. In some implementations, the base station 104 enables and/or disables the feature semi-statically (e.g., via RRC signalling) and/or dynamically (e.g., via DCI signalling).

For example, in FIG. 9, the base station 104 configures the UE 102 using a CG configuration with a single CG occasion per CG periodicity. The base station 104 also configures the UE 102 with the bitmap 924 to indicate to the UE 102 on which CG periods (e.g., CG PUSCH occasions) the UE 102 can transmit the UCI indicating unused CG occasions across different CG periods. In the example of FIG. 9, the UE 102 has data available for transmission on the CG occasion 912. The UE 102 checks the configured bitmap and determines that a UCI indicating the unused CG occasion is to be transmitted together with the CG-PUSCH-1 on the CG occasion 912. The UE 102 determines no data available for transmission for the CG occasion 918 (e.g., the CG occasion 918 is to be unused) and generates UCI indicating the unused CG occasion 912. The UE 102 transmits a CG-PUSCH-1 transmission on the CG occasion 912 with the UCI indicating the unused CG occasion(s). The UE 102 has data available for transmission on the CG occasion 914. The UE 102 checks the configured bitmap and determines no UCI indicating the unused CG occasion is to be transmitted together with the CG-PUSCH-2 on the CG occasion 914. The UE 102 transmits a CG-PUSCH-2 transmission on the CG occasion 914 without the UCI indicating the unused CG occasion(s). The UE 102 has data available for transmission on the CG occasion 916. The UE 102 checks the configured bitmap and determines that a UCI indicating the unused CG occasion is to be transmitted together with the CG-PUSCH-3 on the CG occasion 916. The UE 102 determines no data available for transmission for the CG occasion 918 and generates UCI indicating the unused CG occasion 918. The UE 102 transmits a CG-PUSCH-3 transmission on the CG occasion 916 with the UCI indicating the unused CG occasion(s). The UE 102 has no data available for transmission on the CG occasion 918 and has already indicated the CG occasion will be unused, and should comply with the indication. If there is UCI indicating the unused CG occasion(s) and the UE 102 determines from the bitmap that the UCI is to be transmitted on the CG occasion 918, then in some implementations, the UE 102 still transmits the UCI multiplexed with dummy data. In such cases, the UE 102 still transmits the CG occasion even if indicated as unused to carry the UCI indicating the unused CG occasion(s). In other implementations, the UE 102 does not transmit any data on the CG occasion 918 and does not transmit the UCI (i.e., the UE 102 drops the UCI). In other implementations, the UE 102 postpones the UCI to the next used CG occasion.

In some implementations, the UE 102 generates the UCI indicating the unused CG occasion(s) at the start of the CG period. In some other implementations, the UE 102 generates the UCI indicating the unused CG occasion(s) separately for each CG occasion carrying the UCI. In some implementations, the UE 102 transmits the same UCI in the CG occasion(s) carrying the UCI. In some other implementations, the UE 102 transmits different and/or updated UCI in the CG occasion(s) carrying the UCI, and the UE 102 overwrites the CG occasions that are going to be unused. In some other implementations, the UE 102 transmits consistent UCI in the CG occasion(s) carrying the UCI (i.e., the UCI content is different but the unused CG occasions are constant).

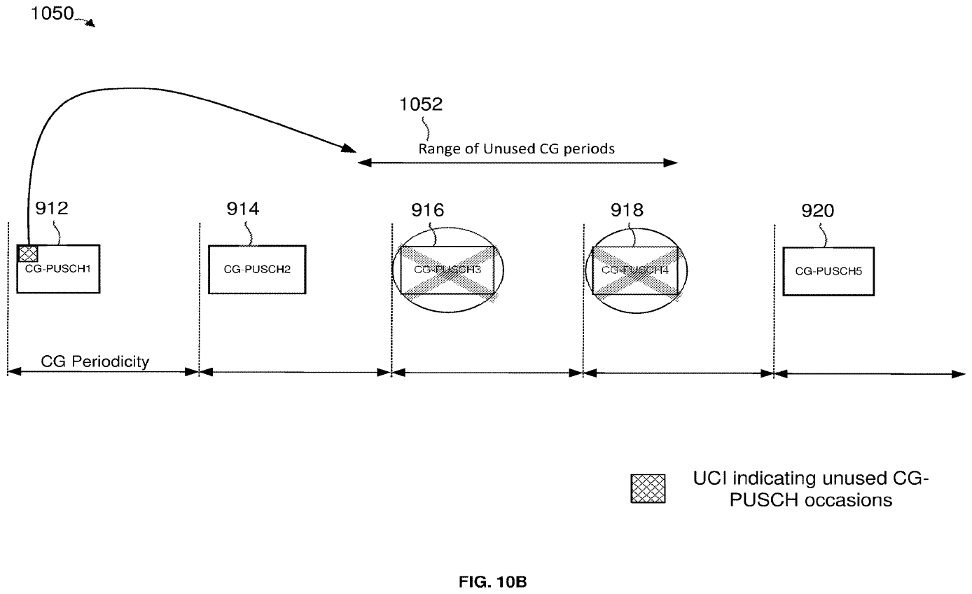

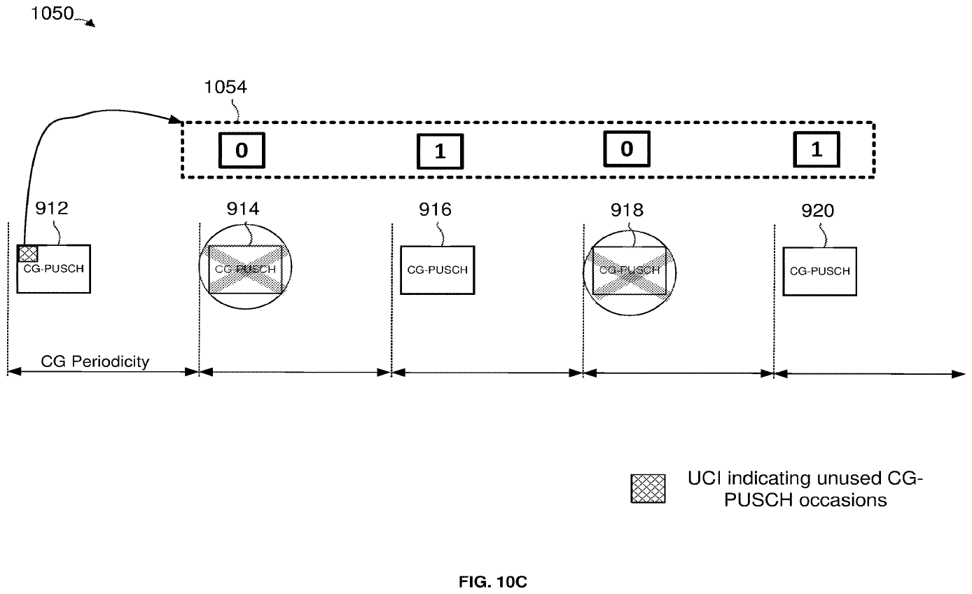

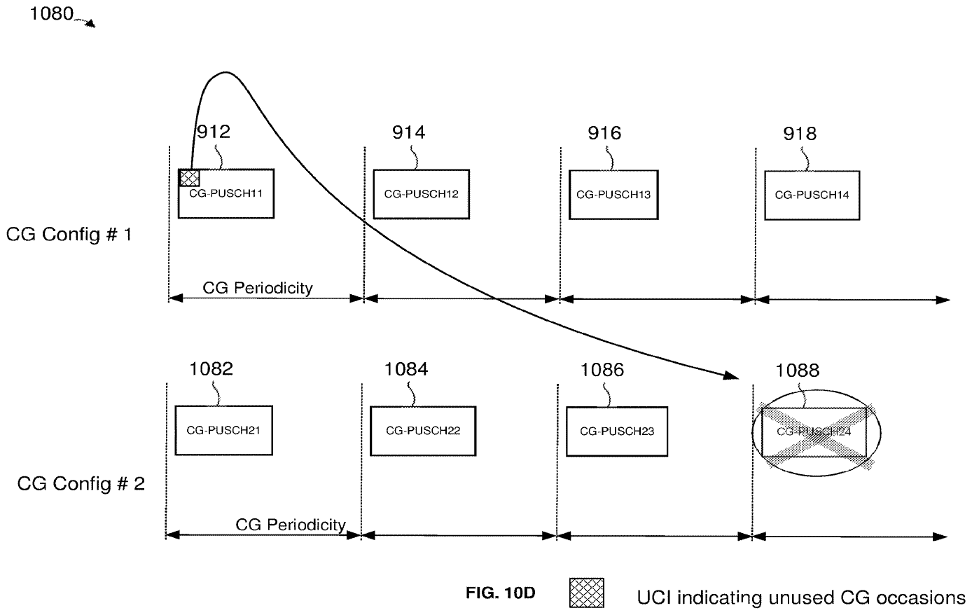

Referring next to FIG. 10A and based on a single CG configuration (e.g., with a single CG-PUSCH per CG period), the UE 102 periodically transmits a UCI to the base station 104, indicating the CG periods status (e.g., unused CG periods and/or used/to be used CG periods). A periodicity 1012 (and other parameters like start offset) is introduced for the UCI transmission indicating the CG periods status (e.g., unused CG periods or used/to be used CG periods) and, therefore, on which CG periods UCI can be transmitted across different CG periods. In some implementations, the UCI transmission periodicity 1012 (and other parameters like start offset) are configured semi-statically (e.g., via RRC signalling) or dynamically (e.g., via DCI signalling). The signalled UCI indicates whether the UE 102 will use a CG period or multiple CG periods for UL PUSCH transmission. In some implementations, the UCI indicates information related to the CG periods located within the ongoing UCI period, or alternatively indicates information across multiple UCI periodicities. In yet another example, the periodicity (and the other parameters) are configured semi-statically (e.g., via RRC signalling) and adjusted dynamically (e.g., via DCI signalling). In some implementations, the periodic UCI transmission is defined as a UE feature, and the UE 102 reports, to the base station 104, support or lack thereof with regard to the feature. In some implementations, the base station 104 enables and/or disables the feature semi-statically (e.g., via RRC signalling) and/or dynamically (e.g., via DCI signalling).

For example, in FIG. 10A, the base station 104 configures the UE 102 using a CG configuration with a single CG occasion per CG periodicity. The base station 104 also configures the UE 102 with the periodicity 1012 (and a start offset) to indicate to the UE 102 on which CG periods the UE 102 can transmit the UCI indicating unused CG occasions. In the example of FIG. 10A, the UE 102 has data available for transmission on the CG occasion 912. The UE 102 checks the configured offset and the periodicity of UCI transmission, and determines that a UCI indicating the unused CG occasion is to be transmitted together with the CG-PUSCH-1 on the CG occasion 912. The UE 102 determines no data available for transmission for the CG occasion 916 (e.g., the CG occasion 916 is to be unused) and generates UCI indicating the unused CG occasion 916. The UE 102 transmits a CG-PUSCH-1 transmission on the CG occasion 912 with the UCI indicating the unused CG occasion(s). The UE 102 has data available for transmission on the CG occasion 914. The UE 102 checks the configured offset and the periodicity of UCI transmission, and determines no UCI indicating the unused CG occasion is to be transmitted together with the CG-PUSCH-2 on the CG occasion 914. The UE 102 transmits a CG-PUSCH-2 transmission on the CG occasion 914 without the UCI indicating the unused CG occasion(s). The UE 102 has no data available for transmission on the CG occasion 916 and has already indicated this CG occasion will be unused, and should comply with the indication. If there is UCI indicating the unused CG occasion(s) and the UE 102 determines that the UCI is to be transmitted on the CG occasion 918, then in some implementations, the UE 102 still transmits the UCI multiplexed with dummy data. In such cases, the UE 102 still transmits the CG occasion even if indicated as unused to carry the UCI indicating the unused CG occasion(s). In other implementations, the UE 102 does not transmit any data on the CG occasion 916 and does not transmit the UCI (i.e., the UE 102 drops the UCI). In other implementations, the UE 102 postpones the UCI to the next used CG occasion.

In some implementations, the UE 102 generates the UCI at the start of every UCI periodicity and is the same or consistent throughout the UCI periodicity. In further implementations, the UE 102 changes and/or overwrites the UCI (e.g., based on the arrival of new data or the discarding of some data).

Referring next to FIG. 10B, and based on a single CG configuration (e.g., with a single CG-PUSCH per CG period), a UCI in some implementations indicates one or multiple consecutive CG periods as unused. In some such implementations, for the indication, the UCI signals, to the base station 104, a specific range 1052 of CG periods to be declared by the UE 102 as unused. In some implementations, the parameters of the specific range 1052 comprise one or multiple of the following parameters: start index, end index, and/or length. Depending on the implementation, the unit of the parameters is be in terms of slots, OFDM symbols, CG periods, etc. In some implementations, if “slots” is used as the unit, then the reference for the indication is the slot containing the CG-PUSCH carrying the UCI. In some implementations, if “OFDM symbols” is used as the unit, then the reference for the indication is the start or the end symbol of CG-PUSCH carrying the UCI. In some implementations, if “CG periods” is used as the unit, then the reference for the indication is the CG period of the CG-PUSCH carrying the UCI. For example, in FIG. 10B, assuming the CG period transmitting CG-PUSCH 912 is of index 0 (as the CG period carries the indication UCI), the UCI carries the start index 2 pointing to the CG-PUSCH 916 and carries a length equal to 2 to indicate two CG periods as unused. In another example, the UCI carries the start index 2 pointing to the CG-PUSCH 916 and the end index 3 pointing to the CG-PUSCH 918. In some implementations, the UCI also carries any other parameters to indicate, to the base station 104, the location of the CG periods to be unused by the UE 102. In some implementations, the base station 104 configures the UE 102 semi-statically (e.g., via RRC, etc.) or dynamically (e.g., via DCI, MAC-CE, etc.) with the parameters to be used to indicate the range of the unused CG periods (e.g., start, end, length, etc.).

For example, in FIG. 10B, the base station 104 configures the UE 102 using a CG configuration with a single CG occasion per CG periodicity. The base station 104 also configures the UE 102 with UCI occasions to indicate to the UE 102 on which CG periods the UE 102 can transmit the UCI indicating unused CG occasions. In some implementations, the UE 102 indicates a range of unused CG occasions. In the example of FIG. 10B, the UE 102 has data available for transmission on the CG occasion 912. The UE 102 determines that a UCI indicating the unused CG occasion is to be transmitted together with the CG-PUSCH-1 on the CG occasion 912. The UE 102 determines no data available for transmission for the CG occasion 916 and CG occasion 918, and generates UCI indicating the unused CG occasion 916 and CG occasion 918. The UE 102 transmits a CG-PUSCH-1 transmission on the CG occasion 912 with the UCI indicating the unused CG occasion(s). The UE 102 has data available for transmission on the CG occasion 914. The UE 102 determines that no UCI indicating the unused CG occasion is to be transmitted together with the CG-PUSCH-2 on the CG occasion 914. The UE 102 transmits a CG-PUSCH-2 transmission on the CG occasion 914 without the UCI indicating the unused CG occasion(s). The UE 102 has no data available for transmission on the CG occasion 916 and CG occasion 918, and has already indicated the CG occasion 916 and CG occasion 918 will be unused, and the UE 102 should comply with the indication. If there is UCI indicating the unused CG occasion(s), and the UE 102 determines from the configuration that the UCI is to be transmitted on the CG occasion 916 or CG occasion 918, then in some implementations, the UE 102 still transmits the UCI multiplexed with dummy data. In such a case, the UE 102 still transmits the CG occasion even if indicated as unused to carry the UCI indicating the unused CG occasion(s). In other implementations, the UE 102 does not transmit any data on the CG occasion 916 or CG occasion 918, and does not transmit the UCI (i.e., the UE 102 drops the UCI). In other implementations, the UE 102 postpones the UCI to the next used CG occasion.

Referring next to FIG. 10C, and based on a single CG configuration (e.g., with a single CG-PUSCH per CG period), a UCI in some implementations indicates non-consecutive CG periods as going to be unused by the UE 102. In some implementations, the UE 102 signals, to the base station 104, a UCI that carries a bitmap 1054 indicating which future CG periods are going to be unused and/or which CG periods are maintained. Each bit in the bitmap 1054 is associated with one or multiple CG periods. In some implementations, the first bit in the bitmap 1054 points to the first CG period following the CG period carrying the UCI. In further examples, the base station 104 predefines or configures an offset to the UE 102, and the first bit in the bitmap 1054 points to the CG period after an offset number of CG periods. In another example, the base station 104 signals the offset to the UE 102. In some implementations, the base station 104 configures the UE 102 semi-statically (e.g., via RRC, etc.) or dynamically (e.g., via DCI, MAC-CE, etc.) with the parameters of the bitmap 1054 (offset, length, etc.) to be used to indicate the unused CG periods.

Using CG configuration with multiple PUSCH occasions per CG period, if the UE 102 uses a bitmap 1054 in the UCI indicating the CG occasion(s) status (e.g., unused CG occasion(s) and/or used/to be used CG occasion(s)) to the base station 104, one bit in the bitmap 1054 in some implementations is associated with one CG PUSCH occasion, multiple CG occasion(s), or a specific time window. In some implementations, the time window comprises multiple CG periods. The objective of using one bit mapping to multiple CG occasion(s) is to reduce the signalling overhead. In some implementations, a threshold is defined/specified or signalled by the base station 104 to the UE 102 semi-statically (e.g., via RRC, etc.) or dynamically (e.g., via DCI, MAC-CE, etc.). If the number of the CG occasion(s) is below the threshold, then one bit in the bitmap 1054 maps to one CG PUSCH occasion, and if the number of CG occasion(s) is above the threshold, then one-bit maps to multiple CG occasion(s). In further implementations, the size N_{b} of the bitmap 1054 is specified/predefined or signalled by the base station 104 to the UE 102 semi-statically (e.g., via RRC, etc.) or dynamically (e.g., via DCI, MAC-CE, etc.). Assuming the number of CG occasion(s) in one CG period or in a specific window of one or multiple CG periods is N_{occ}, then the number of CG occasion(s) associated with one bit in the bitmap 1054 is derived as

$$⌈ \frac{{N}_{o c c}}{{N}_{b}} ⌉ .$$

If N_{occ} is not a multiple of N_{b}, then for each bit of the first N_{b}−1 bits, one bit is associated with

$$⌈ \frac{{N}_{occ}}{{N}_{b}} ⌉$$

CG occasion(s), and the last bit in the bitmap 1054 maps to

$${N}_{o c c} - ( {N}_{b} - 1 ) * ⌈ \frac{{N}_{o c c}}{{N}_{b}} ⌉ .$$

In some implementations, the base station 104 specifies/defines or signals an offset to the UE 102 semi-statically (e.g., via RRC, etc.) or dynamically (e.g., via DCI, MAC-CE, etc.) to start applying the bitmap 1054. Hence, in some implementations, the bitmap 1054 is applied after a specific offset from the UCI carrying the bitmap 1054.

Using a single CG configuration (e.g., with one CG PUSCH occasion per CG period), if the UE 102 uses a bitmap 1054 in the UCI indicating the CG periods status (e.g., unused CG periods or used/to be used CG periods) to the base station 104, one bit in the bitmap 1054 in some implementations is associated with one CG period, multiple CG periods, or a specific time window. In some implementations, the time window comprises multiple CG periods. The objective of using one bit mapping to multiple CG periods is to reduce the signalling overhead.

Using a CG configuration with multiple PUSCH occasions per CG period, if the UE 102 provides a time duration or a range in the time domain that includes the consecutive CG occasion(s) to be cancelled, in some implementations, then the base station 104 specifies/defines or signals a start and length of the range to the UE 102 semi-statically (e.g., via RRC, etc.) or dynamically (e.g., via DCI, MAC-CE, etc.). In some implementations, the time duration or the range parameters are defined in units of symbols, slots, CG occasion(s), etc. In further implementations, to reduce the overhead, a coarse granularity is used where one unit of the time duration maps to multiple symbols, multiple slots, or multiple CG occasion(s).

Using a single CG configuration (e.g., one CG PUSCH occasion per CG period), if the UE 102 provides a time duration or a range in the time domain that includes the consecutive CG periods to be cancelled, in some implementations, then the base station 104 specifies/defines or signals a start and length of the range to the UE 102 semi-statically (e.g., via RRC, etc.) or dynamically (e.g., via DCI, MAC-CE, etc.). In some implementations, the time duration or the range parameters are defined in units of symbols, slots, CG periods, etc. In further implementations, to reduce the overhead, a coarse granularity is used where one unit of the time duration maps to multiple symbols, multiple slots, or multiple CG periods.

Referring next to FIG. 10D, and assuming a single CG configuration (e.g., with a single CG-PUSCH per CG period), a UCI in some implementations indicates that one or multiple CG periods in another CG configuration (other than the CG configuration on which the UCI is transmitted (e.g., across CG configurations)) are going to be unused by the UE 102. The UE 102 indicates, in the UCI, the identification of the targeted CG configuration (e.g., CG configuration index). The UCI also indicates the identification of targeted CG period(s), and, in some implementations, does so through signalling an offset (in the UCI) with respect to the CG period on which the UCI has been transmitted. In some implementations, the offset is in terms of slots, symbols, or number of CG periods of the current or the targeted CG configuration. In some implementations, the UE 102 indicates, to the base station 104, one single CG period or multiple CG period UCI as unused. In some implementations, if multiple CG periods are indicated as unused, the UE 102 indicates, to the base station 104, in the UCI, a range of unused CG periods, or uses a bitmap 1054 to select the CG periods that are going to be unused.

For example, in FIG. 10D, the base station 104 configures the UE 102 with CG configuration #1 (e.g., including CG occasions 912, 914, 916, and 918) and CG configuration #2 (e.g., including CG occasions 1082, 1084, 1086, and 1088). The base station also configures the UE 102 with the functionality to cancel CG occasions across CG configurations. In the example of FIG. 10D, the UE 102 has data available for transmission on the CG occasion 912. The UE 102 determines that a UCI indicating the unused CG occasion is to be transmitted together with the CG-PUSCH-11 on the CG occasion 912 on configuration #1. The UE 102 determines no data available for transmission for the CG occasion 1088 on the CG configuration #2, and generates UCI indicating the unused CG occasion 1088 on the CG configuration #2. The UE 102 indicates an identification of the CG configuration with unused CG occasions indication.

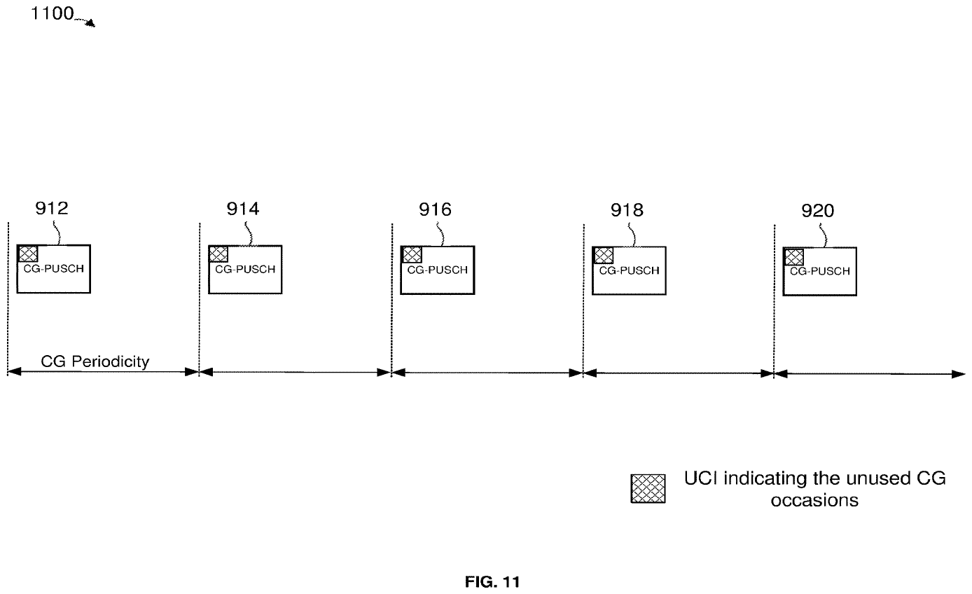

Referring next to FIG. 11, and based on a single CG configuration as defined above, in some implementations the UE 102 transmits UCI transmission indicating the CG periods status (e.g., unused CG periods and/or used/to be used CG periods) to the base station 104 on all UL CG transmissions if a CG PUSCH transmission is taking place. In some implementations, such transmission is less resource efficient but offers more reliability and up-to-date information to the base station 104. In further implementations, the example of FIG. 11 would also require less specification effort and less RRC signalling overhead to configure the scheme. In some implementations, such is defined as a UE feature, and the UE 102 reports, to the base station 104, support or lack thereof with regard to the feature. In some implementations, the base station 104 enables and/or disables the feature semi-statically (e.g., via RRC signalling) and/or dynamically (e.g., via DCI signalling).

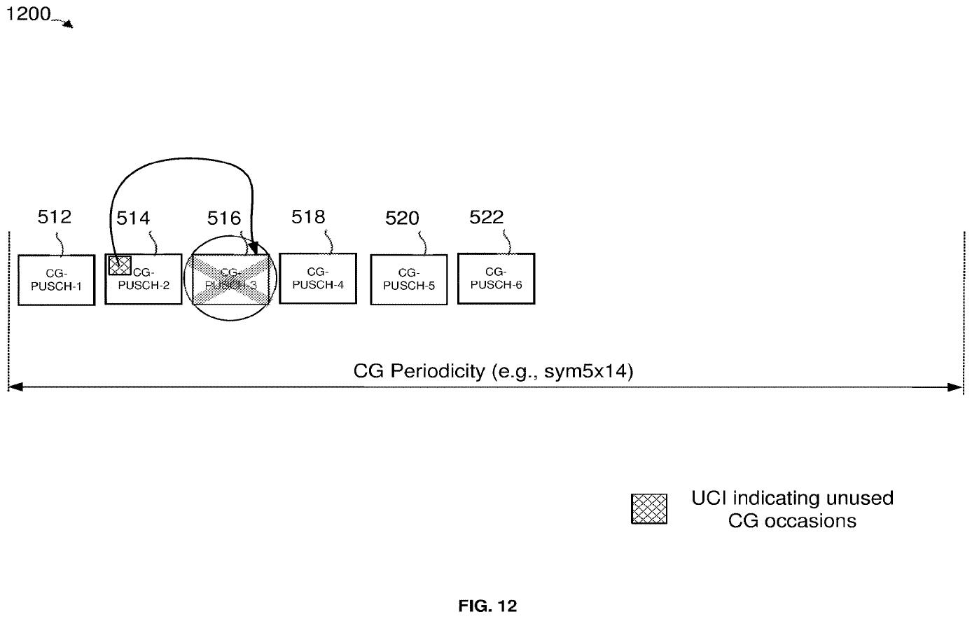

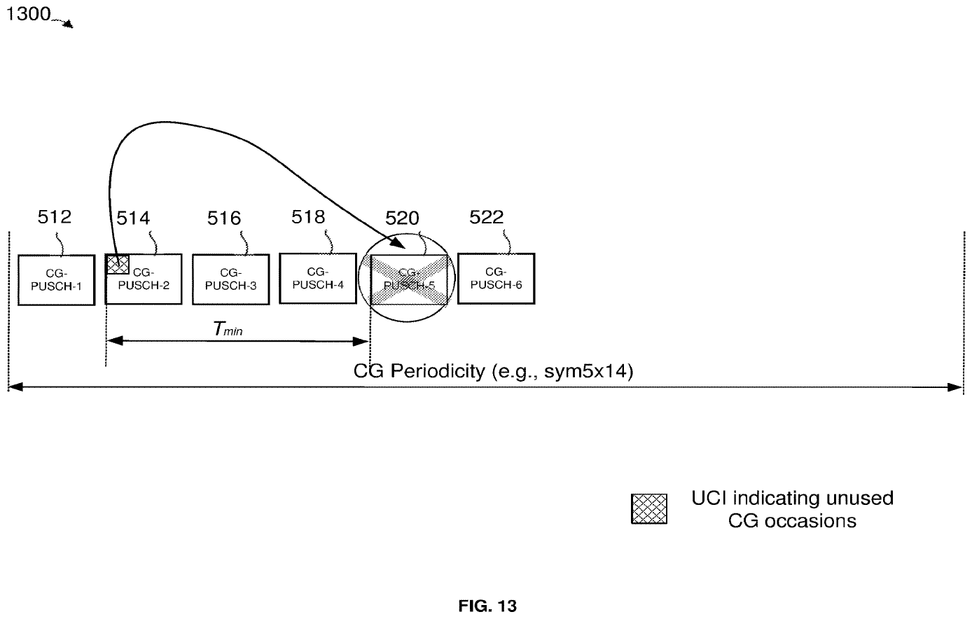

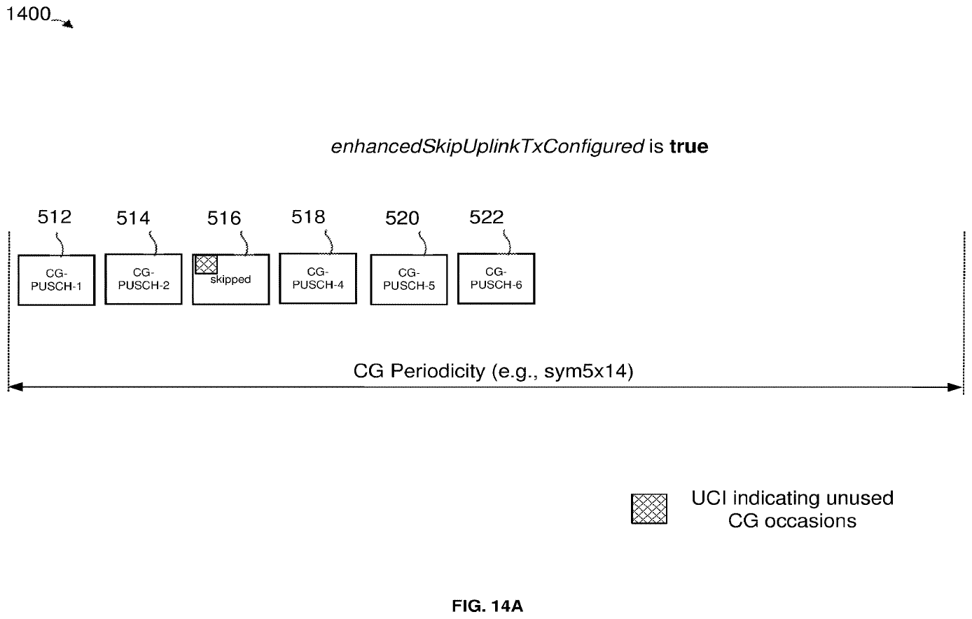

Referring next to FIG. 12, the UCI transmitted with the CG-PUSCH-2 in CG occasion 514 indicates that the following CG occasion (e.g., CG-PUSCH-3 in CG occasion 516) is going to be unused by the UE 102. In some implementations, if the occasions are very close in time, then the base station 104 does not have enough time to recycle the unused occasion and schedule the unused occasion to other UEs. The base station 104 uses a particular quantity of time the base station 104 to receive and decode the dynamic UCI indication and then schedule other UEs with the unused resources, otherwise the base station 104 will not reuse the indicated unused CG occasions. Hence, FIG. 13 introduces a minimum duration between the UCI indication and the indicated unused CG occasions below.

FIG. 13 shows an example of a minimum time Tmin that, in some implementations, is defined or configured for the indication of the unused CG occasions. In some implementations, the base station 104 configures the UE 102 semi-statically (e.g., via RRC) with a minimum time between the instant of sending the UCI indicating the CG occasion(s) status (e.g., unused CG occasion(s) and/or used/to be used CG occasion(s)) and the temporal location of the unused CG occasions. Depending on the implementation, the minimum time is in units of milliseconds, number of slots, number of OFDM symbols, or in terms of number of CG occasions. In some implementations, the base station 104 specifies/defines or configures the time (e.g., via RRC signalling). In another example, multiple values are predefined, and the base station 104 configures the UE 102 with one of these values.

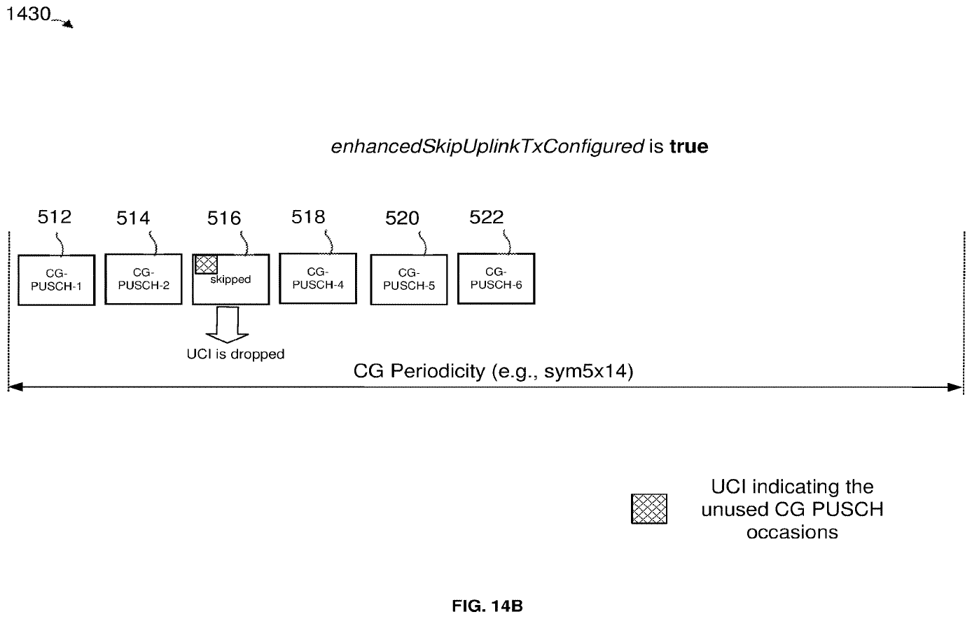

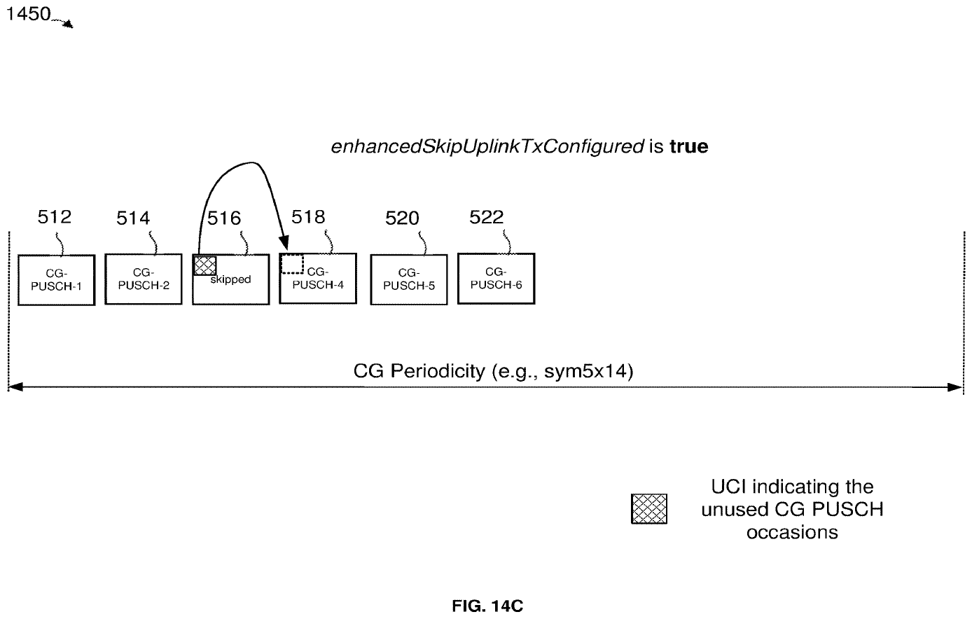

Referring next to FIG. 14A, if enhancedSkipUplinkTxConfigured is true and is therefore configured to the UE 102 (i.e., skipping UL configured grant if no data is available for transmission and no UCI is to be multiplexed on the corresponding PUSCH of the UL grant), and if the CG occasion carrying the UCI indicating the CG occasion(s) status (e.g., unused CG occasion(s) and/or used/to be used CG occasion(s)) fulfils some of the skipping conditions (e.g., defined in 3GPP TS 38.321), then the UE 102 skips the CG occasion 516. In such implementations, the system specifies to the UE 102 whether the UE 102 is to skip the CG occasion 516 that is supposed to carry the UCI indication about the unused CG occasions or the UE still is to transmit the CG-PUSCH with UCI. In some implementations, an existing (e.g., Rel 16) UL CG skipping mechanism is not altered, and the CG occasion to carry the UCI (indicating the unused CG occasions) is considered not fulfilling the first condition (e.g., no UCI to be multiplexed on the PUSCH transmission). As such, the UE 102 still transmits on the CG occasion with the UCI. Because there is no data to be transmitted, the UE 102 appends and/or multiplexes dummy data in some implementations to the UL PUSCH transmission. Hence, in the first embodiment, if the Uplink CG Skipping is configured together with the UCI indicating the CG occasion(s) status (e.g., unused CG occasion(s) and/or used/to be used CG occasion(s)), then the UE 102 does not skip the CG occasion carrying the UCI signalling the CG occasion(s) status.

In further implementations, the UE 102 skips a CG occasion carrying the UCI signalling the unused CG occasions. And if the UE 102 skips the CG PUSCH occasion, then, in some implementations, the UE 102 drops the UCI as shown in FIG. 14B, or transmits the UCI on the earliest CG occasion carrying a PUSCH, as shown in FIG. 14C (e.g., the UCI is postponed to the next CG occasion carrying a PUSCH). If the UE 102 transmits a dynamic grant PUSCH ahead of any other CG PUSCH, the UE 102 multiplexes the UCI indicating the CG occasion(s) status (e.g., unused CG occasion(s) and/or used/to be used CG occasion(s)) with the dynamic grant PUSCH. In further implementations, the UE 102 transmits the on the next PUCCH occasion.

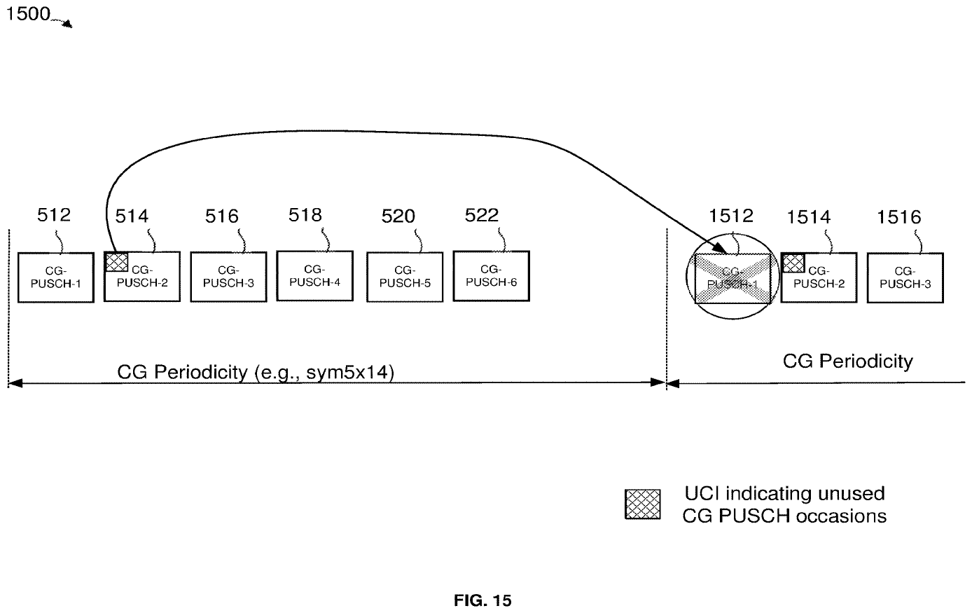

Referring next to FIG. 15, for the CG configuration with multiple PUSCH occasions per CG period, a UCI indicating the CG occasion(s) status (e.g., unused CG occasion(s) and/or used/to be used CG occasion(s)) in some implementations indicates unused CG occasion(s) in the same CG period and/or in future CG periods (e.g., the next CG period(s)). In some implementations, the UE 102 signals, to the base station 104, in the UCI, the index of the CG period(s) concerned by the UCI indicating the CG occasion(s) status (e.g., unused CG occasion(s) and/or used/to be used CG occasion(s)). In some implementations, the UCI indication targets a specific occasion or a specific range of CG occasions, or is a bitmap of CG occasions to be unused. In further implementations, the UCI indication also operates across CG configurations (i.e., a UCI in one CG period of a specific CG configuration indicates one or multiple CG occasion(s) as unused in another CG configuration). In such cases, the UCI also carries the identification of the other CG configuration(s) (e.g., a CG configuration index). The UCI also carries the identification of the targeted CG period in the other CG configuration. For example the UCI carries the offset between the current CG period in the current CG configuration (carrying the UCI) and the targeted CG period in the targeted CG configuration.

In some implementations or scenarios, a UCI cancels a single CG occasion in a future CG period (or several periods) or all of the CG occasions within the future CG period, or multiple such periods. For example the UE 102 determines that data will be unavailable for uplink transmission for the entire duration of one or more CG periods. Further, in some implementations or scenarios, a UCI cancels one or more occasions within the same CG period as well as one or more occasions within another (e.g., immediately subsequent) CG period.

In a CG configuration (e.g., 3GPP 5G NR Rel-15 to Rel-16), the UE 102 determines whether or not to transmit on the configured CG resources. In the UCI indicating the CG occasion(s) status (e.g., unused CG occasion(s) and/or used/to be used CG occasion(s)), one bit in some implementations indicates that the CG PUSCH occasion is unused, or, in further implementations, one bit indicates that the CG PUSCH occasion is used. In still further implementations, one bit indicates that the CG PUSCH occasion follows the legacy procedure (i.e., the UE is allowed to transmit or not to transmit on this occasion). In some implementations, the base station 104 defines/specifies or configures the bit significance to the UE 102.

Referring generally to FIGS. 6-15, and as indicated with reference to some of these diagrams, these techniques can apply to a single CG period or multiple CG periods. Further, these techniques can apply to a single CG configuration or multiple CG configurations.

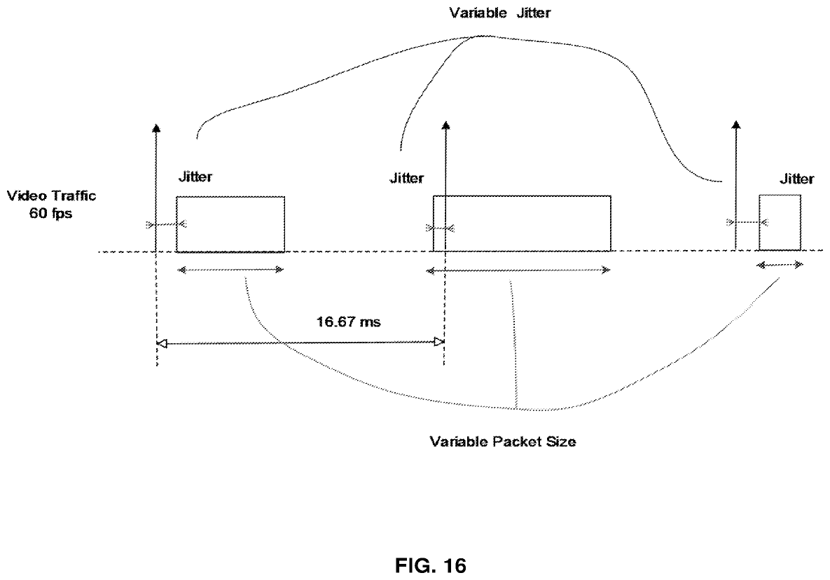

FIG. 16 shows an example of the XR traffic shape and how jitter affects XR traffic. As shown in FIG. 16, XR traffic may be quasi-periodic traffic with a period equal to the inverse of the XR frame rate. Hence, if the frame rate is 60 frames per second (fps), the periodicity is 16.67 milliseconds (ms). The XR traffic in some implementations suffers from jitter (e.g., 802, 806, 810) (e.g., due to the delay variations at the codec to encode the video frames). In the example of FIG. 8, the jitter is able to be statistically modelled as a truncated Gaussian distribution with 2 ms standard deviation and +/−4 ms range. The XR packet sizes (e.g., frame sizes) are also large and variable due to the variability in the video frame content (e.g., I-frames, P-frames, B-frames), and, in some implementations, are also statistically modelled as a truncated Gaussian distribution. For example, in the exemplary embodiment of FIG. 16, a mean frame size is an average data rate, divided by an fps value for the video stream, divided by 8 bytes. Further, in some such implementations, the STD, max, and min values of the mean are 10.5%, 150%, and 50%, respectively, of the mean. For example, given a data rate of 30 Mbps and an fps of 60 fps, then mean is 64 kilobytes. In some implementations, for the UL direction, the pose/control information is modelled as periodic (e.g., 4 ms periodicity used in RAN 1) with fixed packet size (e.g., 100 bytes used in RAN 1) and with no jitter. For UL XR traffic (e.g., UL AR traffic), the traffic is modelled with no jitter values (e.g., in RAN 1), as the jitter for UL traffic is smaller than for DL traffic.

It will be understood that such values and modelling are exemplary only for the sake of readability and illustration, and that additional alternate values can similarly apply.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, the “LTM command” can be replaced by “serving cell change command”, “Layer 1/Layer 2 switching command”, “lower layer switching command” or “lower layer serving cell change command”. In some implementations, “some” means “one or more”. In some implementations, “at least one” means “one or more”. In some implementations, the “DU configuration” can be replaced by “cell group configuration”. In some implementations, the “cell index” can be replaced with “serving cell index”, “LTM cell index”, “special cell (SpCell) index”, “PCell index” or “PSCell index”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method for uplink transmission implemented in a user equipment (UE), the method comprising:
receiving, from a radio access network (RAN), a periodic configuration that indicates (i) a plurality of occasions for uplink transmission within each period, and (ii) a subset of the plurality of occasions, the subset including two or more occasions, in which the UE is allowed to transmit a control indication related to another occasion; and
transmitting, in a first occasion included in the subset, the control indication for a second occasion not included in the subset and subsequent to the first occasion, the control indication based on whether the UE will transmit data in the second occasion.

2. The method of claim 1, wherein:
the subset is two or more occasions scheduled consecutively in the plurality of occasions.

3. The method of claim 1, further comprising:
determining that the UE will not transmit any data in the second occasion;
wherein the transmitting of the control indication is in response to the determining.

4. The method of claim 1, wherein:
the periodic configuration is a configured grant (CG) configuration; and
the period is a CG period.

5. The method of claim 4, wherein each of the plurality of occasions is a CG physical uplink shared channel (PUSCH), CG-PUSCH, occasion.

6. The method of claim 1, wherein the control indication is an uplink control indicator (UCI).

7. The method of claim 1, wherein the second occasion is in a same period as the first occasion.

8. The method of claim 1, wherein the second occasion is in a period subsequent to a period of the first occasion.

9. The method of claim 1, further comprising:
transmitting the control indication within each occasion in the subset.

10. The method of claim 1, wherein:
the subset of the plurality of occasions is a non-contiguous subset of the plurality of occasions, so that, between two consecutive occasions in the subset, there is an occasion that belongs to the plurality of occasions but does not belong to the subset.

11. The method of claim 10, wherein the periodic configuration includes a bitmap specifying the subset within the plurality of occasions.

12. A method for configuring uplink transmission from a UE, the method implemented in a base station and comprising:
transmitting, to the UE a periodic configuration that indicates (i) a plurality of occasions for uplink transmission within each period, and (ii) a subset of the plurality of occasions, the subset including two or more occasions, in which the UE is allowed to transmit a control indication related to another occasion; and
receiving, in a first occasion included in the subset, the control indication for a second occasion not included in the subset and subsequent to the first occasion, the control indication indicating whether the UE will transmit data in the second occasion.

13. The method of claim 12, wherein:
the subset is two or more occasions scheduled consecutively in the plurality of occasions.

14. The method of claim 12, wherein:
the periodic configuration is a configured grant (CG) configuration; and
the period is a CG period.

15. A device comprising:
a transceiver; and
processing hardware configured to implement a method of any of the preceding claims.
